(19) United States
(12) Patent Application Publication
(10) Pub. No.: US 2013/0047123 A1
(43) Pub. Date: Feb. 21, 2013

(54) METHOD FOR PRESENTING USER-DEFINED MENU OF DIGITAL CONTENT CHOICES, ORGANIZED AS RING OF ICONS SURROUNDING PREVIEW PANE

(71) Applicants: Robert May, Sausalito, CA (US); Nadav Meir Neufeld, Sausalito, CA (US); Jeffrey Solari, San Francisco, CA (US); James Granger, Larkspur, CA (US)

(72) Inventors: Robert May, Sausalito, CA (US); Nadav Meir Neufeld, Sausalito, CA (US); Jeffrey Solari, San Francisco, CA (US); James Granger, Larkspur, CA (US)

(73) Assignee: RINGGUIDES INC., Sausalito, CA (US)

(21) Appl. No.: 13/498,126

(22) PCT Filed: Sep. 24, 2010
(86) PCT No.: PCT/US10/50301

§ 371 Date: Nov. 6, 2012

Related U.S. Application Data
(60) Provisional application No. 61/245,629, filed on Sep. 24, 2009.

(51) Int. Cl. G06F 3/048

(52) U.S. Cl. 715/834

(57) ABSTRACT

RingGuide is an organizational and social media methodology and system that enables new forms of distributed interfaces on any 2D or 3D class electronic device. The RingGuide comprises a hierarchy of Rings displaying on one or more of these devices. The Rings may contain Asset Cells representing a database record available in associated local or remote databases (a movie, video or graphical advertisement, TV show, metadata, etc.); Code Cells capable of executing specific functionality, such as search, “show by time”, a widget that displays realtime weather information or a separately launchable application such as an instant messaging client; Element Cells showing locally or remotely update-able user interface elements, and Link Cells that refer to sub-Rings that may be organized by genre, media owner brands, etc.

This application claims the benefit of U.S. Provisional Application 61/245,629 filed Sep. 24, 2009, the entirety of which is herein incorporated by reference.

### BACKGROUND

The quantity and formats of digital content (video, music, graphics, text, and other media) is increasing exponentially. This content is increasingly stored in many locations and a plethora of organizational structures.

Many different electronic devices and input mechanisms (“hardware”)—each equipped with various computer firmware, operating systems, applications (“software”) and “user interfaces” (“UIs”)—are used by consumers and businesses to discover, collect, and consume digital content.

These trends make content discovery and consumption difficult and cumbersome, since the user must remember how to operate a multitude of different device UIs and the locations and taxonomy of potentially desirable content. The growing ubiquity and heterogeneity of electronic devices, video displays, input mechanisms, computer applications, and the proliferation of formats and location of content assets across networks, and within databases has led to increased fragmentation in device operation, presentation and function (“user experience”) of user interfaces. Simultaneously, users from many cultures and levels of sophistication are seeking simplicity of operation and the ability to discover, collect, use and share assets from any source on and between different devices in a consistent fashion at any time. However, different electronic devices—such as cell phone, televisions, desktop computers, notebook computers, remote controls, audio-visual receivers—typically present very diverse user interfaces (or more general “man-machine interfaces” MMIs) that require the user to learn the operation of each electronic device. While the same content that users access is available across many different devices—a user could access a given video on his cell phone, television, computers, and home theater system—the devices themselves have very different user interfaces. This makes accessing content difficult and cumbersome, since the user has to remember how to operate a multitude of different devices. Thus the increasing distribution of content across different system and devices directly collides with this growing system-wide diversity of electronic devices that consumer use to access such content. This results in increased customer support costs, user frustration, and lower overall device sales. What is needed is a single, consistent, easy-to-use, culturally neutral, extensible interface for electronic devices that meets these needs across many use cases and on many electronic devices.

Today's user interfaces use organizational structures conceived and developed assuming a system creator pre-defines hierarchal content categories or permits a user to manually create these categories and assumes all content assets would be stored and organized in one or more databases within this pre-defined hierarchy. This enables the division of all system assets into a predictable number of matrices equal to the number of total assets divided by the minimum average number of cells on a single matrix. While these pre-defined hierarchies may be used in fixed asset collections such as video-on-demand catalogs, a modern interface must permit a flexible, extensible methodology and schema for creating, organizing and displaying dynamically or automatically generated assets such as streams and events as well as database resident items.

### SUMMARY OF THE INVENTION

RingGuide is a system and method for organization of assets in defined collections. The collections are defined either by the system or by users and a collection is organized in a hierarchy relative to the other collections. A collection can be static or dynamic. Collections are presented to the user in a consistent graphical arrangement. Generally the graphical arrangement is a ring structure, comprising an ordered series of cells arrayed around a central display area. Assets and other rings as accessed through the cells and the content of assets is displayed in the central display area. The graphical arrangement further includes functions such as controls for devices in communication with RingGuide and searching for content whether locally or at a location remote to the user; links to other content such as other collections of assets, documents or websites; and advertisements. Collections can be shared by users. Shared collections can be monetized, usually in association with their including advertisements.

The RingGuide methodology is applicable to many applications including, but not limited to, a media guide, video conference application, and web browser.

In one embodiment RingGuide is a media guide.

Additionally or alternatively RingGuide controls devices.

Any embodiment of RingGuide may include one or more features such as spiral navigation, overflow rings, back rings, simultaneous multiple sequential searches, RingPin, dynamically generated rings, sharing of Rings, personalization of Rings.

In any embodiment, Rings optionally include advertisements and sponsored Rings.

Any embodiment of RingGuide operates on a variety of devices.

### BRIEF DESCRIPTION OF FIGURES

FIG. 1 illustrates the RingGuide interface according to one embodiment.

FIG. 2 illustrates a 3D environment for RingGuide according to one embodiment.

FIG. 3 illustrates nomenclature for Rings according to one embodiment.

FIG. 4 illustrates Overflow Rings according to one embodiment.

FIG. 5 illustrates spiral navigation according to one embodiment.

FIG. 6 illustrates a Back Ring according to one embodiment.

FIG. 7 illustrates the system architecture according to one embodiment.

FIG. 8 illustrates the architecture of the RingGuide Hosting Service according to one embodiment.

FIG. 9 illustrates the use of a proxy interface according to one embodiment.

FIG. 10 illustrates RingGuide as media guide according to one embodiment.

FIG. 11 illustrates RingGuide as media guide with eyebrow according to one embodiment.

FIG. 12 illustrates search functionality in RingGuide according to one embodiment.

FIG. 13 illustrates search functionality in RingGuide according to a second embodiment.

FIG. 14 illustrates simultaneous search functionality in RingGuide according to one embodiment.

FIG. 15 illustrates a Ring of dynamic content according to one embodiment.

FIGS. 16A-B illustrate Ring sharing according to one embodiment.

FIG. 17 illustrates advertising in shared Rings according to one embodiment.

FIG. 18 illustrates RingGuide used for video conferencing according to one embodiment.

FIG. 19 illustrates RingGuide used for controlling and setting up devices according to one embodiment.

FIG. 20 illustrates Ring Pin according to one embodiment.

FIG. 21 illustrates creating a clip according to one embodiment.

FIGS. 22A-B illustrate RingGuide used as a program schedule according to one embodiment.

### DETAILED DESCRIPTION

### I. Introduction and Overview of RingGuide

### A. Architecture

RingGuide includes a user interface for electronic devices. RingGuide's operation and organizational schema is substantially identical with any content and on any electronic device. RingGuide-equipped devices can include 2D display-equipped devices such as cell phones, smart phones, personal digital assistants, tablets, notebook and desktop computers, automobile and other vehicle displays, as well as larger devices, such as kiosks, televisions, and billboards equipped with many different display technologies including AMOLED, plasma, DLP, LCD, “digital ink”, and so forth. RingGuide devices can also include simulated or immersive 3D environments.

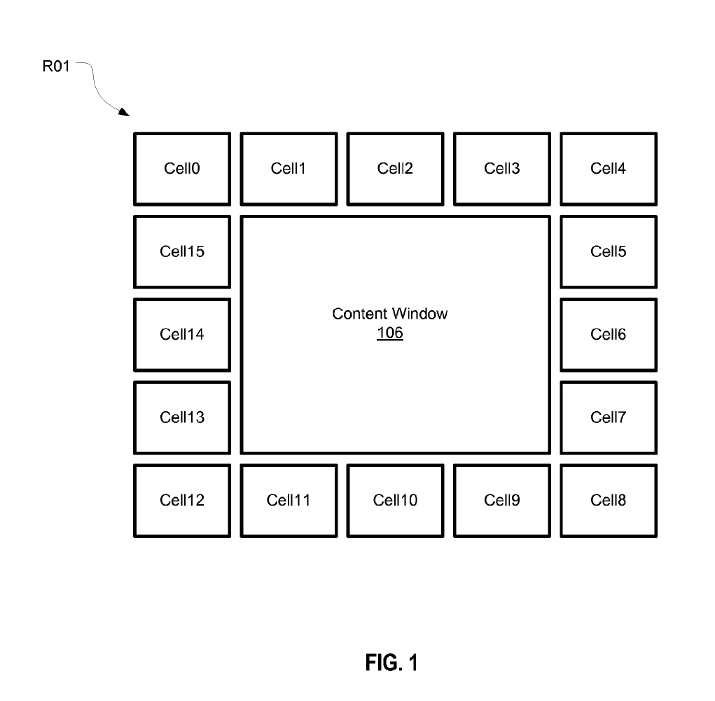

As illustrated in FIG. 1, in one embodiment, RingGuide can appears on a 2D device's display as one or more “Rings” R01 of a precise number of cells organized along the periphery of the display around a center window 106 (hereinafter “Content Window”). Each cell can represent either an interface element (hereinafter “Element Cells”), media/content/contact/advertising/metadata assets (hereinafter “Asset Cells”), cell-specific executable code (hereinafter “Code Cells”), or a representational reference to another collection of cells organized into a sub-Ring (hereinafter a “Link Cell”). When an Asset Cell is a person or contact information linked to a person it is referred to as a Person Cell. A Ring can contain either a homogenous or heterogeneous mixture of these Cell types.

The number and size of Cells within a Ring can be adjusted to fit the size, resolution and form factor of the display device or other factors. The position of individual Cells within a Ring, and their type, can be modified algorithmically, in response to external sensors, or manually set by an operator or user.

The “topmost” Ring in any Ring hierarchy (Ring R1) can be called the Home Ring. Any Ring, including this Home Ring, can be linked to a number of dependent sub-Rings, where the number of said sub-Rings is equal to the number of Link Cells in the referencing Ring. Each of the dependent sub-Rings may in turn be linked to a number of dependent sub-sub-Rings equal to the number of Link Cells in each referring sub-Ring, and so on. A group of Rings and sub-Rings linked by Link Cells is called a Ring Collection.

Navigation from Cell to Cell and Ring to Ring can be done by user input, “passive browse” timers and other automatic or algorithmic methods.

RingGuide's fractal, linked architecture yields a potentially unlimited number of Rings, each Ring connected and organized in a preferably consistent structure to all others, but containing individual Cells whose location and function are specific to their Ring's organizing criteria and purpose(s). It can be seen that this architecture can efficiently contain and present exponentially large numbers of choices and interface functions in a standard, predictable fashion. This consistency and extensibility are some of the benefits of the RingGuide methodology.

### B. Assets

Assets displayed by RingGuide can be generated by or retrieved from local or remote applications, persistent storage media (e.g., magnetic, solid state, optical, or other), from real-time events such as streaming video or audio, or from local or remote databases accessed through one or more networks. In one embodiment, RingGuide presents assets without regard to where each asset is located, whether locally on the device, within a home network using standards such as DLNA and UPnP, within business networks such as intranets, for example, or through external private or public network(s). In some use cases, RingGuide may not display an asset itself, but instead display a reference to an asset or group of assets (for example, webpages, URIs and URLs). Any Ring may mix the presentation of local assets, remote assets, and references to remote assets. Remote assets can be remote system assets or remote network assets. Remote system assets are located at the RingGuide system. Remote network assets are located at third party systems and databases.

It is a benefit of the Ring system that whatever the format of the actual Asset, the Asset may be represented within a Ring in various ways: textually, graphically, thumbnails or icons by metadata, animations, motion video, etc. depending for example, on user preferences, operator rules, Ring location, processor or network conditions, etc. An Asset's representation may vary from Ring to Ring or time to time.

Generally, though not always, an Asset or one or more of its representations are displayed in RingGuide's Content Window when an Asset Cell that references the Asset or Link Cell that contains references to said Asset is highlighted. When the Cell that links to/references the Asset is highlighted, it is said to be in “focus.” When an Asset or Link Cell is focused, its Asset(s) can then be controlled by the Ring interface and Asset-related information can be retrieved and displayed by the RingGuide system. For example, in the case of a video Asset that is focused, the Content Window displays the Asset as a preview or alternatively, full-length content. Metadata related to the Asset is displayed in the Content Window, and the playback of the preview/content can be controlled through the Ring interface. Whether the Content Window uses a preview or plays full-length content is determined by user preferences, business rules or preferences of the operator of the RingGuide system. Highlighting of Cells and thus focus of the Asset can be done by user input, algorithmically in accordance with adjustable system settings, business rules, or by the operator. The order, timing and other characteristics of such highlighting and display can be controlled algorithmically or by user input upon the Cells or a previewed Asset and/or its representation. In many use cases, RingGuide switches from the default Ring display to a full-screen display of the selected asset in response to certain inputs, as described in the Global Media Guide use case below.

### C. Elements

User interface elements and assets presented in the RingGuide and their functionality can be retrieved or generated locally from executable code instructions embedded within the RingGuide-equipped device's hardware (“firmware’), or software operating as part of a device's operating system, its middleware, applications, widgets and/or high-level scripts executing on the user's device, or through requests over one or more networks (a) directly to a server, applications, or widgets hosted by RingGuide's owner, licensee, or third party non-licensors, (b) indirectly through third party APIs (application programming interfaces) that, in turn, provide elements for display or execution on the user's local device, (c) composited into a stream delivered across a network to a device, or (d) a mixture of the above methods. Elements may be displayed as (a) an Element Cell, (b) as part of other RingGuide application/service components, or (c) as on-screen overlays generated by RingGuide or other software capable of presenting on the device's display.

### D. Functional Operations Across Device Classes

Preferably, RingGuide functions substantially identically on any device. Within the limitations of input methods and other capabilities specific to the machine, use cases such as discovery, consumption, customization, sharing, system configuration, etc. are preferably initiated and controlled using the same input methods and actions within any similar Ring or cell. This ideal, however, may be modified if desired by a device manufacturer, application/service developer, or, if enabled, by the operator or user.

In 2D device classes, each Ring (and its components) is displayed on-screen, and the user uses input devices in a manner defined by the RingGuide application or service to move sequentially from Cell to Cell within a Ring and from Ring to Ring within a Ring Collection.

In 3D and immersive environments (and in some sophisticated 2D displays capable of simulating 3D), the user can appear to move “through” a Home Ring and its sub-Rings, with the 3D/immersive device(s) giving the user perceptual feedback as to their position. In one 3D embodiment, Rings are organized linearly along the “z” axis allowing the user to view, and move “forward” and “backward” through multiple Rings sequentially by the previously described user operations of focusing and selecting Cells or already described automatic, aggregated, or algorithmic inputs.

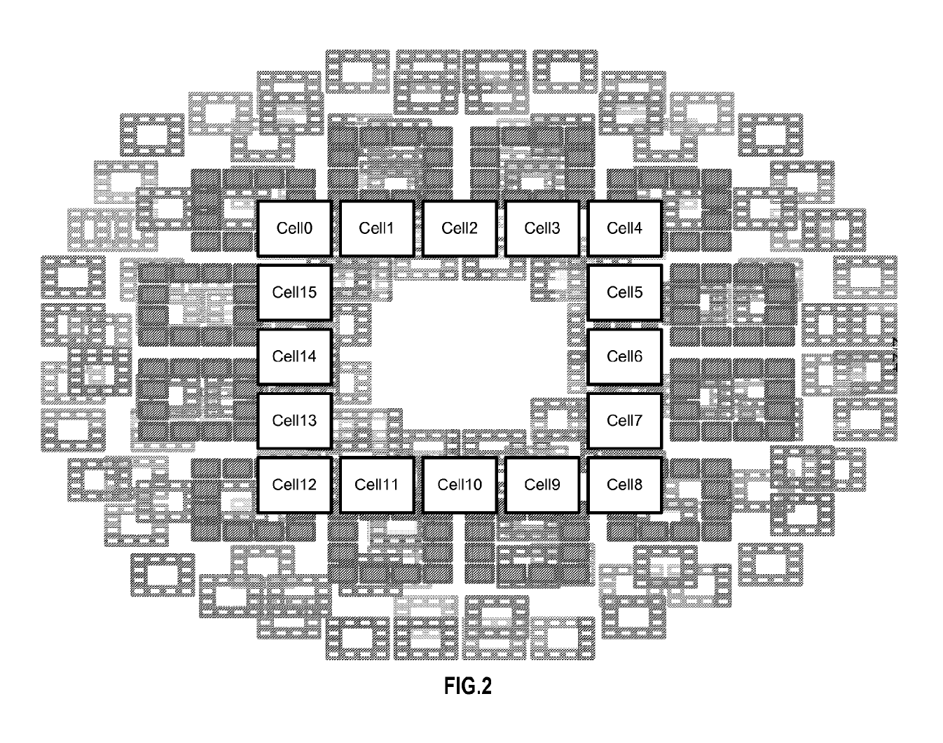

Alternatively, Rings can be presented within simulated and immersive 3D systems in the form of Ring Clouds, whose appearance resembles “constellations” of Rings, with relationships between them shown by various methods, including size, visual weighting, color, creator, audiovisual/textual labels, social groups, connecting graphics or animations. Navigation and display of these constellations can be independent of user's select and focus operations, for example a user can use gestural input methods to “reach into” a Ring Collection and select a deep Ring, or rotate the Ring cloud to reveal specific Rings, cells, system components, content, and metadata. FIG. 2 is a 2D representation of how a 3D environment would look to a user.

### E. User Input Methods

A key benefit of RingGuide is the consistency of operation, whatever the type of input device(s). In addition to the automatic “passive browse” method, RingGuide users can manually operate RingGuide using a remote control (not shown) having a five-way navigation interface including left, right, up, down, and Select buttons. Other input methods can include a computer mouse and keyboard, touch- or gesture-enabled controlled smartphones or tablet devices, or sensor-equipped input mechanisms for 2D or 3D “space”.

In one 2D embodiment, the right and left buttons of a remote control can be used to move focus around a Ring's cells clockwise and counterclockwise, respectively, and the up or down buttons invoke a picklist menu. Picklist items and location are contextual depending on the focused Ring region. The picklist for each of Cell°, Cells 1-15, the Content Window, and fullscreen content regions have items specific to the Cell, Content Window or fullscreen region from which the picklist was invoked. Once invoked, up/down buttons move focus within a picklist. A Select button acts on the focused Cell if no picklist is open, or upon the focused item in the open picklist.

### F. Ring to Ring Navigation

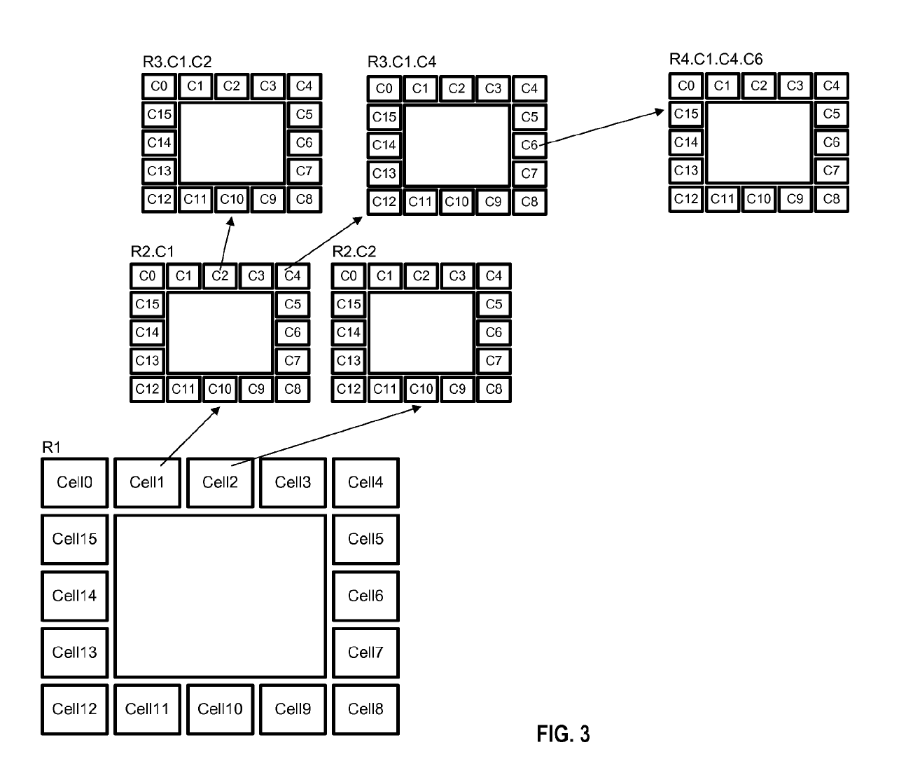

FIG. 3 illustrates a naming convention for Rings according to one embodiment. Ring R1 is the Home Ring and the top level in the hierarchy. Cell1 and Cell2 are both Link Cells to sub-Rings. The sub-Rings are named using their level in the hierarchy as well as the path of Cells used to get to that sub-Ring. The sub-Ring linked from Cell1 is R2.C1 as it is one level below R1 and is a sub-Ring from Cell1 in R1. Similarly, the sub-Ring linked from Cell2 in R1 is R2.C2. From R2.C1 there are two sub-Rings linked from Link Cells C2 and C4, respectively. The sub-Ring linked from C2 is R3.C1.C2 because it is the third level in the hierarchy and comes from Cell1 in R1 and C2 in R2.C1. Similarly, the sub-Ring linked from C4 is R3.C1.C4. A fourth level ring is linked from C6 in R3.C1.C4 and is named R4.C1.C4.C6.

When the user is viewing a Ring (the “Active Ring”), its Content Window shows content or previews related to whatever Cell is focused in the Active Ring. If the focused Cell is a Link Cell, the content or previews are related to the sub-Ring linked to that Cell.

In one 2D embodiment, the user is viewing Active Ring R1. Cell 0 is focused. The “passive browse” feature is enabled and so, without user input, the passive browser timer lapses, automatically moving the focus to LinkCell Cell 1, which triggers display of content/previews associated with sub-Ring R2.C1.

The R1 viewer sees interesting content while LinkCell Cell 1 is focused, and presses the Select button which causes a transition to the new Active Ring R2.C1. The Content Window of Ring R2.C1 now displays contents/previews related to its Asset Cells or related to the subRings R3.C1.C2 and R3.C1.C4 linked to Link Cells C2 and C4 in Ring R2.C1, and so on. It can be seen that with three clicks on LinkCells, the user is able to view 64 choices in three Rings.

### G. Overflow Rings

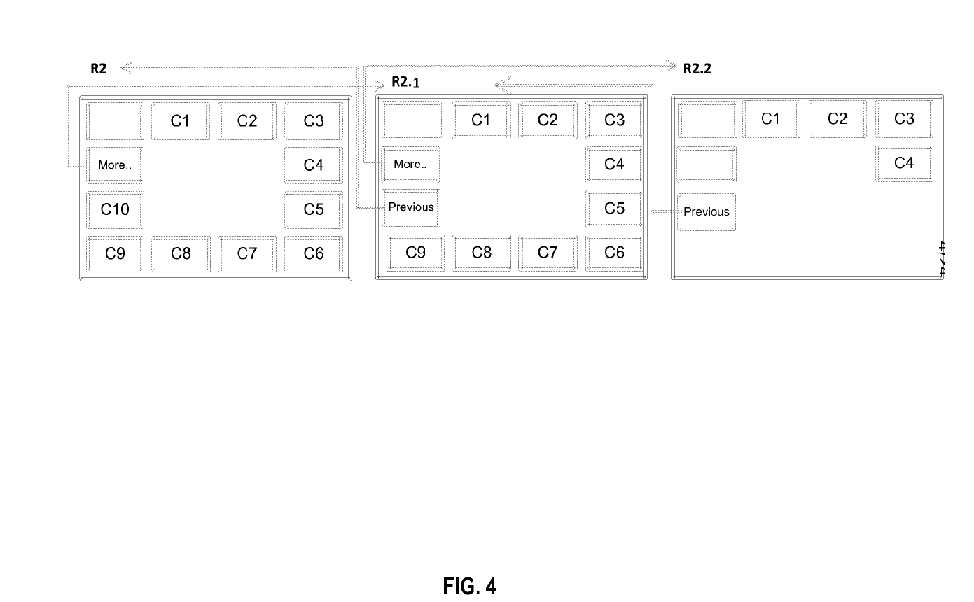

In some cases, as in a search that results in more items than can fit on a single Ring, it is necessary to have multiple Rings on the same hierarchal level. In one embodiment, navigation through these Overflow Rings is enabled through two or more Element Cells linked to the Ring and Overflow Rings. As shown in FIG. 4, these Element Cell(s) are placed within each first and Overflow Ring (preferably in consistent Cell locations within each Ring for ease of navigation). A “More.” Cell is placed in the C11 position on Ring R2 and also its first Overflow Ring, R2.1. “Previous” Cells are in the C10 position on R2.1 and R2.2. Selecting the “More.” Cell in Ring R2 displays the first Overflow Ring R2.1. Selecting the “Previous” Cell in Ring R2.1 displays Ring R2, and so on.

In another embodiment, navigation to Overflow Rings on the same level can be done by selecting from pick list menu items such as “More like this . . . ” and “Previous like this . . . ” within each Ring.

### H. Spiral Navigation

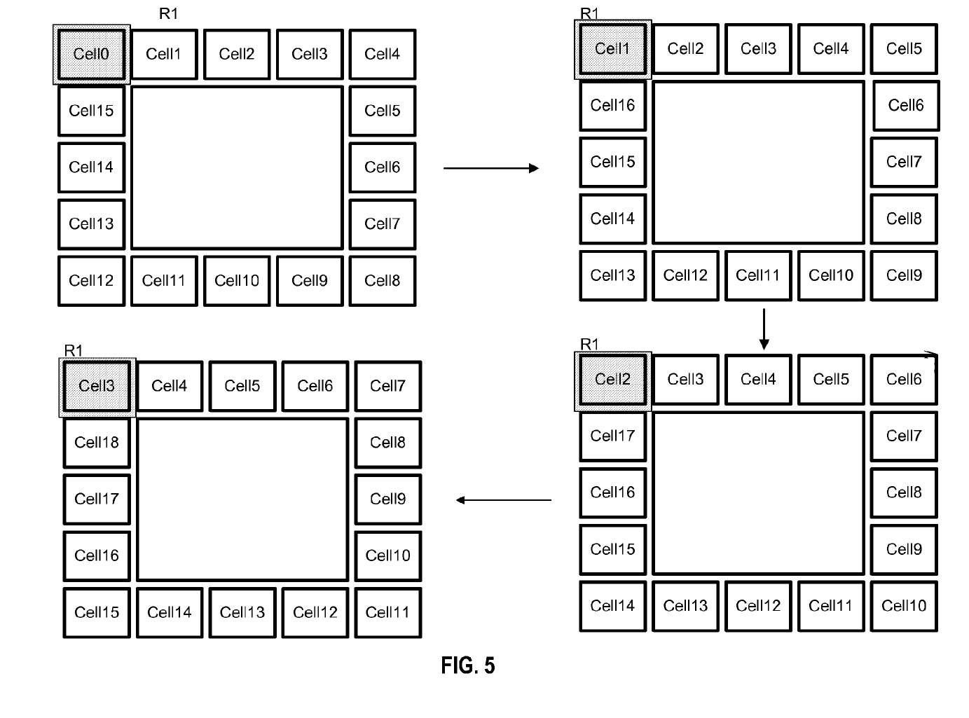

In another embodiment, the RingGuide provides methods of spiral navigation to address the situation where there are more Cells than will fit in a Ring. As illustrated in FIG. 5, in this navigation method a range of cells appear to flow into or out of a single displayed Ring in response to user input. A user starts at Ring R1 of Cells 0-15, where Cell 0 has a fixed focus element (the “Fixed Focus Cell”). As the user presses the left or right remote control buttons or arrow keys, the focus remains fixed, and the graphic thumbnails or other Asset representations move through Cell 0's fixed focus. FIG. 5 illustrates the user moving in a clockwise direction and thus the Cells shifting in a counterclockwise direction. Alternatively, the user can move through the Cells in a counterclockwise direction and the Cells shift then in a clockwise direction. When the user has Cell 1 in the former position of Cell 0, there is space on the Ring R1 for Cell 16 to appear where Cell 15 has been previously. With user input, such as selecting select or enter keys, on an Asset represented within the Fixed Focus Cell, the navigation behavior is as described above (if focused Link Cell, a new Ring opens with its Cell 0 focused, if focused Asset Cell, its content shows fullscreen).

### I. Back Ring

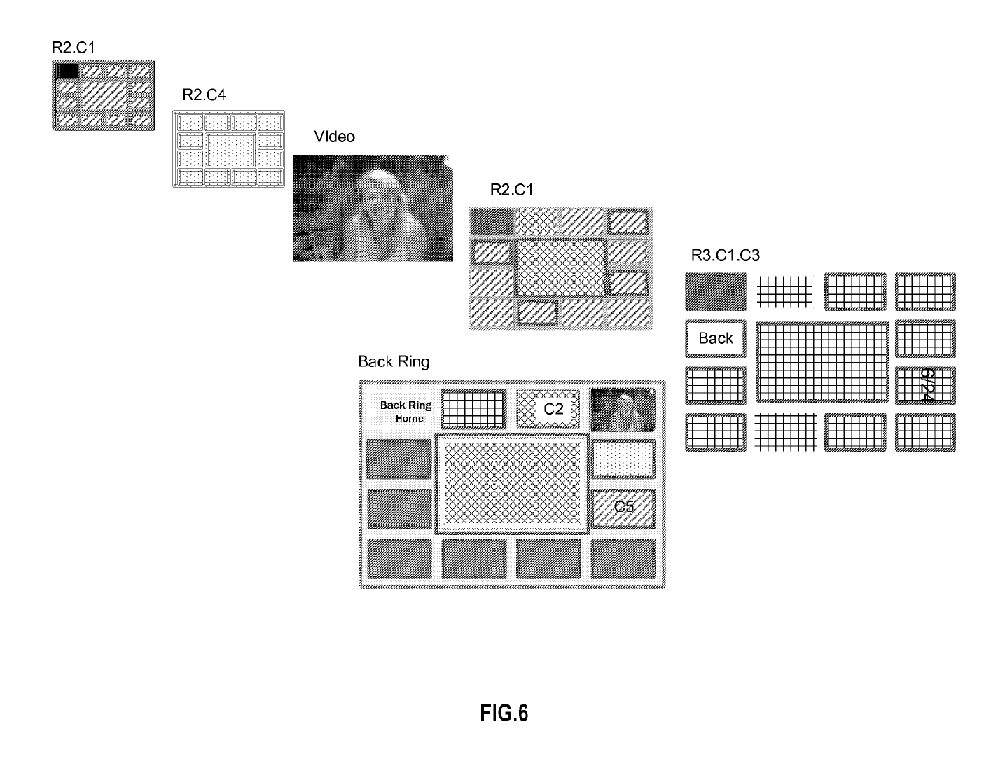

As can be appreciated, when a user is browsing, he or she may wish to go back to a particular Ring or content that was visited previously. Rather than having to navigate back up and/or down the hierarchy in an attempt to find the item of interest, RingGuide stores the previously visited Rings and Cells and builds a Back Ring to which the user can go to see the previously viewed content in one place. FIG. 6 illustrates an example Back Ring. Pressing the “Back” Element Cell on Ring R3.C1.C3 takes the user to the Back Ring which displays the last n cells viewed/used by the user (where n is equal to the number of Cells in the standard use case layout, less any reserved Cells). Alternatively, the Back Ring is accessed from a picklist. The user can then highlight and select any of these last n cells to return directly to the activity/location they were engaged in at that point in time.

Listed from most recent to least recent, the user had previously been viewing Ring R3.C1.C3, Ring R2.C1, a Video, Ring R2.C4, and Ring R2.C1. The Back Ring presents Link Cells to those prior Rings and Asset Cells to those prior videos in reverse chronological order going clockwise. Alternatively, the history is displayed clockwise in chronological order.

Upon opening the Back Ring, the default highlighted Cell is C2. This corresponds to the last Ring viewed prior to the Ring from which the “Back Ring” command was invoked. Selecting any Link Cell in Back Ring re-displays the Ring to which it is linked, preferably playing the same preview as was last viewed when the Ring was left. Ring R2.C1 was visited twice during this user's browsing session. However, each time that R2.C1 was visited, a different Cell in the Ring may have been in focus. Therefore, the R2.C1 is represented in the Back Ring twice and when the LinkCell C2 is selected, the Cell within R2.C1 in focus during that visit will be in focus when R2.C1 is displayed. Similarly, when the Link Cell C5 is selected, the Cell within R2.C1 in focus during that earlier visit will be in focus when R2.C1 is displayed.

### J. System Operators and Client Implementations

In one embodiment, RingGuide will be used by a system operator to offer an application or service to users. This operator can be RingGuide's owner or licensees, such as conventional cable, satellite, or mobile operators, media owners, CDNs, ad networks, original equipment manufacturers (“OEMs”), or others. Alternatively, a RingGuide service may be operated by its users, either collectively or by a sub-group of users. Finally, it is possible these two examples will operate simultaneously.

In each scenario, the RingGuide application/service may execute on a user's local client device (a) in a Internet web browser session (b) within a locally installed, network-connected or non-network-connected application, browser plug-in, firmware, or other locally executable code, (c) as a client-server application executing between the user's device over one or more networks to one or more servers, (d) as a server-side executable which sends a displayed stream to the device over a network in response to user input over one or more networks or (e) in a combination of the above scenarios. The RingGuide application/service can run as a self-contained system or as part of, or in conjunction with other applications or services. The RingGuide can also operate as a local application on a single machine, accessing content from local storage through a local hosting service.

Operators or users can “reserve” one or more Cells in a Ring, and the functions or contents of these reserved Cells can be controlled by the user, Operator, advertisers, or other third parties. The functions or contents of these reserved Cells can be persistent as the Ring or Ring Collection containing said Ring is modified by one or more users. The reserved cells can include content, messages, advertisements, or embedded functionality inserted by the user, Operator, advertisers, or other third parties.

Operators can enable Code Cells, Rings, and Ring Collections to generate reports to the Operator's or third party system(s) for diagnostic, marketing, DRM, and other purposes.

### II. System Architecture

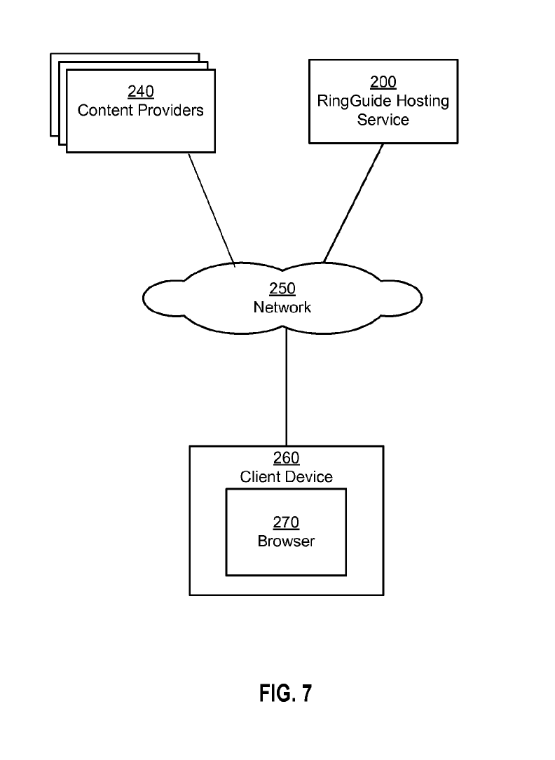

FIG. 7 is a high-level block diagram of a computing environment supporting the RingGuide according to one embodiment, for example when RingGuide operates as a networked service. FIG. 7 illustrates a RingGuide hosting service 200, a plurality of content providers 240, and a client device 260 connected by a network 250. Only one client 260 is shown in FIG. 7 in order to simplify and clarify the description. In practices, the computing environment 100 can have thousands or millions of clients 260, as well as multiple RingGuide hosting services 200 and advertising campaign management systems 227. A client 260 can be any type of electronic device, including a 2D or 3D class electronic device.

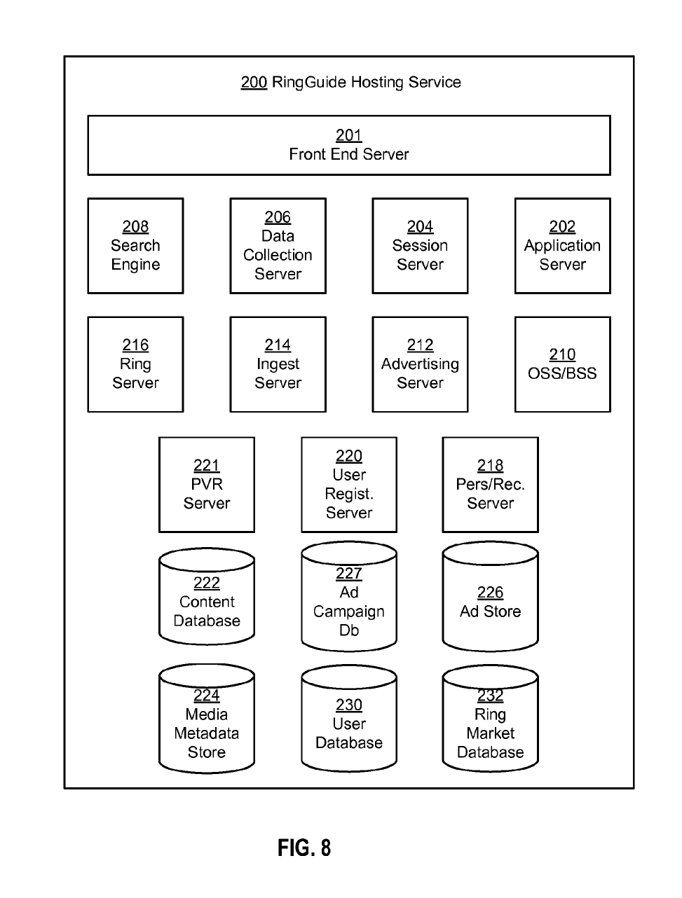

In one embodiment, the RingGuide hosting service 200 provides content (including video, audio, text and other file types, computer applications, widgets, interface elements, or other items) to the client 260 via the network 250. As will be described below in more detail with respect to FIG. 8, the RingGuide hosting service 200 includes databases for storing media content (e.g., videos, web pages, audio files, presentations, etc.), metadata descriptions of some or all content items, user demographic data, and data for tracking the user views of content, user interface elements, and applications.

The client 260 is a computer or other electronic device used by one or more users to perform activities including viewing content and advertising received from the RingGuide hosting service 200.

The client 260, for example, can be a personal computer executing a web browser 270 that allows the user to browse and search for media content available from the RingGuide hosting service 200. Computer-based client devices can support basic web protocols such as TCP/IP, HTML, and Javascript, as well as video decoding (WMV, H.264) and video formats (Flash, MPEG-4, etc.). In one embodiment, for this type of client 260, local RingGuide client is implemented using client side Javascript.

In other embodiments, the client 260 is a network-capable device other than a computer, such as a personal digital assistant (PDA), a mobile telephone, a pager, a television “set-top box,” etc. In one embodiment, a RingGuide-equipped set top box, PVR and similar clients 260 support an MHP stack (defined in Digital Video Broadcasting (DVB), Multimedia Home Platform (MHP) Specification 1.0.3, ETSI ES 250 812 V1.1.1 (2003-12); or Digital Video Broadcasting (DVB); Multimedia Home Platform (MHP) Specification 1.1.1, ETSI TS 102 812 V1.2.1 (2003-06), or revisions thereof), or alternatively, an OCAP stack (defined in OpenCable™ Application Platform Specification, OCAP 1.0 Profile, OC-SP-OCAP1.0-116-050803, and revisions thereof). In one embodiment, a RingGuide-equipped mobile telephone clients support DVB-H (Digital Video Broadcasting (DVB); Transmission System for Handheld Terminals (DVB-H); ETSI EN 302 304 v1.1.1)) for mobile video reception. In one embodiment, RingGuide-equipped devices support DLNA and UPnP protocols for local area network connections to compliant devices.

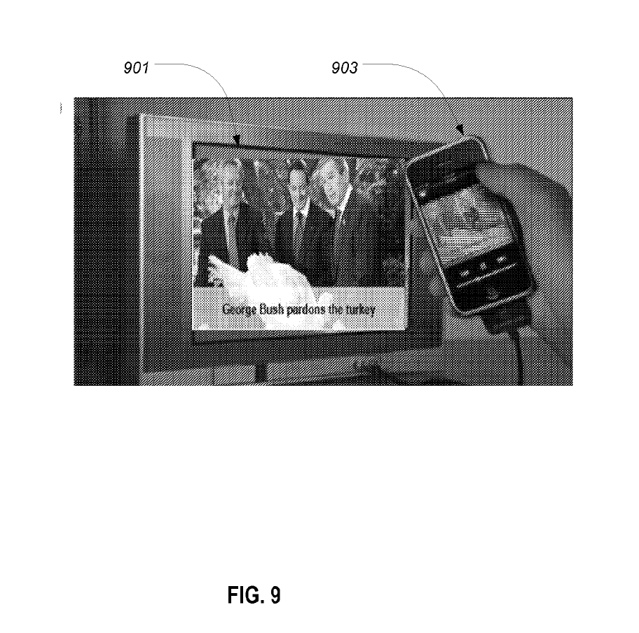

The RingGuide client functionality can be implemented as an application based on the appropriate middleware stack set forth above. The functionality of the RingGuide is described above, and further illustrated in FIGS. 9-22. The RingGuide provides a consistent, extensible user interface experience and functionality across all types of client devices. The RingGuide can be implemented as an extension of the Matrix Architecture User Interface described in U.S. Pat. No. 5,544,354 which is incorporated by reference herein.

Whereas consumers use clients 260 to access the RingGuide hosting service 200 primarily to discover, organize and share multimedia media content (e.g., videos, audio, animations, etc.), RingGuide system operators may use clients 260 to insert, update and delete service features or functionality, electronics manufacturers or retailers can use clients 260 to load, modify or delete user interface elements, individual users, content publishers and advertisers/sponsors/agencies can use clients 260 to access the RingGuide hosting service 200 through appropriate APIs to publish, edit and delete content and manage advertising campaigns, as will be described in detail below.

The network 250 represents the communication pathways between the RingGuide hosting service 200, the content providers 240, and the clients 260. In one embodiment, the network 205 includes the Internet. The network 250 can also utilize dedicated or private communications links that are not necessarily part of the Internet. In one embodiment, the network 250 uses standard communications technologies and/or protocols. Thus, the network 250 can implement technologies such as 802.3, 802.11 and other communications protocols. At the transport level, network 250 can use the transmission control protocol/Internet protocol (TCP/IP), the hypertext transport protocol (HTTP), the simple mail transfer protocol (SMTP), the file transfer protocol (FTP), etc. The data exchanged over the network 250 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

The RingGuide hosting service 200 operates using a large number of server-grade computers, which are comprised of one or more processors, coupled to a bus, a memory, a storage device, and a network interface. The processor may be any general-purpose processor. The storage device is, in one embodiment, a hard disk drive but can also be any other device capable of storing data, such as a writeable compact disk (CD) or DVD, or a solid-state memory device. The memory may be, for example, firmware, read-only memory (ROM), non-volatile random access memory (NVRAM), and/or RAM, and holds instructions and data used by the processor. The network adapter couples the computer to the network 250. As is known in the art, the computer is adapted to execute computer program modules. As used herein, the term “module” refers to computer program logic and/or data for providing the specified functionality. A module can be implemented in hardware, firmware, and/or software. In one embodiment, the modules are stored on the storage device, loaded into the memory, and executed by the processor. In another embodiment utilizing the Model-View-Controller methodology, when the user request is received by the client 260 (the “View”), the client then requests a RingID from the webserver (the “Controller”), which passes the request to the database schema (the “Model”) which fetches and provides the data plus a RingID to the Controller, which in turn organizes the data into the appropriate Ring arrangement, then sends this Ring, its RingID, titles for the Cells in the Ring, thumbnails for the Assets in the Ring, metadata, etc. to the client for display to the user. The computer is configured to perform the specific functions and operations by various modules, for example as detailed in FIGS. 9-22 and thereby operates as a particular computer under such program control.

The types of computers utilized by the entities of FIG. 7 can vary depending upon the embodiment and the processing power utilized by the entity. For example, a client 260 that is a mobile telephone typically has limited processing power, a small display, and might lack a pointing device. A server in the RingGuide hosting service 200, in contrast, may comprise multiple blade servers working together to provide the functionality described herein.

FIG. 8 is a high-level block diagram illustrating elements of the RingGuide hosting service 200 according to one embodiment. Some embodiments of the RingGuide hosting service 200 have different and/or other modules than the ones described here. Similarly, the functions can be distributed among the elements in accordance with other embodiments in a different manner than is described here. Depending upon the embodiment, certain modules can be incorporated into other modules of the RingGuide hosting service 200 and/or other entities on the network 250, including the client 260. Regardless of the particular arrangement, in all instances the RingGuide hosting service 200 is specifically configured by the modules it is executing and thereby operates as a particular computer system.

As shown in FIG. 8, the RingGuide hosting service 200 includes a front end server 201, application server 202, a session server 204, a data collection server 206, Operational Systems and Support (OSS) and Business Systems Support (BSS) server 210, an advertising server 212, an ingest server 214, a Ring server 216, a personalization/recommendation server 204, a user registration server 220, and a PVR server 221. The RingGuide hosting service 200 also includes a content database 222, a media metadata store 224, an ad store 226, an ad campaign management database 227, and a user database 230.

The front end server 201 manages the details of communication with client devices 260, including both that have registered with the RingGuide hosting service 200 as well as unregistered users, and further manages connections across Internet, cable and telephone systems, as well as wireless and cell phone systems, as needed. It also provides security services to ensure connection integrity, client validation, and firewall services.

For web-based clients 260, the front end server 201 provides a user interface in a web page, and interactions with clients 260 are handled through the user interface. For example, a user may select Rings (or specific content) to view through the webpage provided to user's client 260. The front end server 201 receives requests from the clients 260 and communicates with the other servers of the RingGuide hosting service 200 to process the requests.

The application server 202 delivers the relevant guide client application to the client device. For example, a viewer may register her cell phone client device 260 with RingGuide hosting service 200. The application server 202 will deliver the cell phone client for the specific middleware to the cell phone. The application server 202 also supports web (e.g., Java, Flash), OCAP, DVB-MHP, or DVB-H platform and interfaces as appropriate for the various types of client devices. The application server 202 is further adapted to interface with an OCAP application server, MHP application server, DVB-H, DVB-J, or other types of application servers, as needed to obtain applications for the particular execution platform of the client device.

The Session Server 204 manages interactions with the various client devices 260, providing:
1. Both current state and profile information to the client;
2. Handing off Cell and Ring requests to the Ring Server;
3. Managing search and query requests;
4. Routing recording requests to a client device with recording capability (e.g., PVR, mobile device);
5. Updating the viewer profile database;
6. Handing off relevant requests and information to the OSS/BSS server (if present, see below); and
7. Handing off of higher level tasks such as building viewer profile templates and content templates to the Personalization/Recommendation server 218, which manages user creation and sharing of Rings, and stores user-created rings in the user database 230.

The data collection server 206 collects data on the demographic profile of the users made available from user registration in the RingGuide system, or from their social network friends on interconnected networks such as Facebook, MySpace and the like, either in aggregated non-identifiable forms or personally-identifiable forms, depending on user permissions and regulatory or business rules. Additional data stored on the data collection server includes type and location of client machine used to access the user's Rings and specific Cells and content items therein. Additionally, the data collection server 206 contains information on the user's—and the user's friends, depending on user permissions and regulatory or business rules—creation, modification, sharing, “Liking” of, and comments on Cell, Ring, and RingChains. This information can be accessed by Ring creators, advertisers and sponsors to determine in which Rings and cells they would like to advertise to suggest content, Rings or other users that may be of interest to the user, and be used by the RingGuide operator to determine “Top Favorites” and other rankings lists, provide analytics data to third parties and RingGuide users, and other uses.

The search server 208 processes any search queries received by the front end server 201 from users seeking to view content, directly, rather than browsing through a Ring. A search query received by the front end server 201 from a user includes search criteria, such as keywords that may identify content the user is interested in viewing. The search server 208 uses the search criteria to query the metadata of files stored or referenced in the content database 222. The search results from the query are transmitted to the front end server 201 for presentation to the user. In addition, the search server 208 can handle sophisticated tasks such as simultaneous multiple sequential searches (as described below), as well as building and executing search templates.

The operational systems and support (OSS) and business systems support (BSS) gateways server 210 handle all the business- and system-level requests or transactions initiated by viewers from the RingGuide hosting service 200 including content purchase/rental, permissions and accreditation. In an embodiment where the client devices 260 are set top boxes and related units, these transactions include PPV, on-demand purchases, package subscription, advertisement offer fulfillments, and a variety of other services.

The advertising server 212 provides advertisements into various cells of the RingGuide user interface. The advertising server 212 can reserve a cell in any Ring into which the system's business rules allow advertisement/sponsor insertions. Depending on these rules, reserved cells can be in some or all operator-, sponsor-, or user-created Rings. The advertising server 212 maintains an ad store 226 of advertisements and sponsored Rings from which it selects ads or sponsored Rings for insertion into cells. The advertising server 212 provides interfaces for Ring creators, advertisers and sponsors to insert, modify, and delete advertisements and sponsored Rings from the ad store 226, as well as interfaces for creating, modifying, and deleting advertising campaigns. The ad store 226 also maintains sponsors accounts, payment information. The ad campaign database 227 stores advertising campaign parameters, including which ads/sponsored Rings are associated with which campaign, conditions under which ads/sponsored Rings in a given campaign should be eligible for insertion (e.g., keywords, demographic preferences, schedule and timing preferences) and coupons, credits, bids or payments for advertisement placements.

The ingest server 214 processes video streams and files received by the front end server 201 from users, content providers, advertisers, or sponsors for posting to the RingGuide hosting service 200. In one embodiment, the processing of a video file received includes assigning a video identification (video ID) to the video file and storing the video file in a content database 222. Other steps that may be involved in the processing of the received video file before storing in the content database 222 include formatting (e.g., transcoding), compressing, metadata tagging, content analysis, and/or other data processing methods, or retransmission as streams.

The ingest server 214 receives metadata from a variety different sources (content publishers, independent film and TV metadata providers like Rovi and Gracenote, video metadata, TV program schedules, VOD data, user-generated metadata, web data (e.g., Internet Movie Database, etc.), as well metadata included in a content file received from the user. User-generated metadata may include information entered by the user about their submissions and third party content, such as the title, description, and tag information. Content providers can establish flags for ratings, parental controls, placeshifting capability, and any other type of asset-related control function. The ingest server 214 translates such metadata from whatever protocol in which it arrives into a single form understood by the rest of the application and stores it for later use in the media metadata store 224.

The Ring server 216 processes Ring requests from users (“viewers”) generated during search, active or passive browsing, or other commands. In one embodiment, the Ring server 216 receives a request from a viewer to access a Ring when the viewer selects a LinkCell in a Ring. The request received from the viewer includes the cell ID of the cell the viewer has selected. The Ring server 216 uses the cell ID to determine the associated Ring, and then locate the content or Uniform Resource Identifier links to content that is required to populate the specified Ring. Content or links may be stored in a database at the client device, locally at the service 200 (in content database 222) or at content providers 240. Non-database content, such as streaming media is obtained from content providers 240 as well as from the service 200 if the source is local to the service 200. The Ring server 216 also determines which content is to be played in the center window. The Ring server 216 then provides information describing the organization of the Ring and the content for the Ring to the client device, which creates the Ring for the user. Metadata associated with the Ring may also be presented with the Ring, such as titles in the Ring eyebrow (see below), and so forth.

The Ring server 216 also manages a Ring market, in which uses can share, trade, buy and sell customized rings. Transaction information for the ring market is stored in the Ring market database 232.

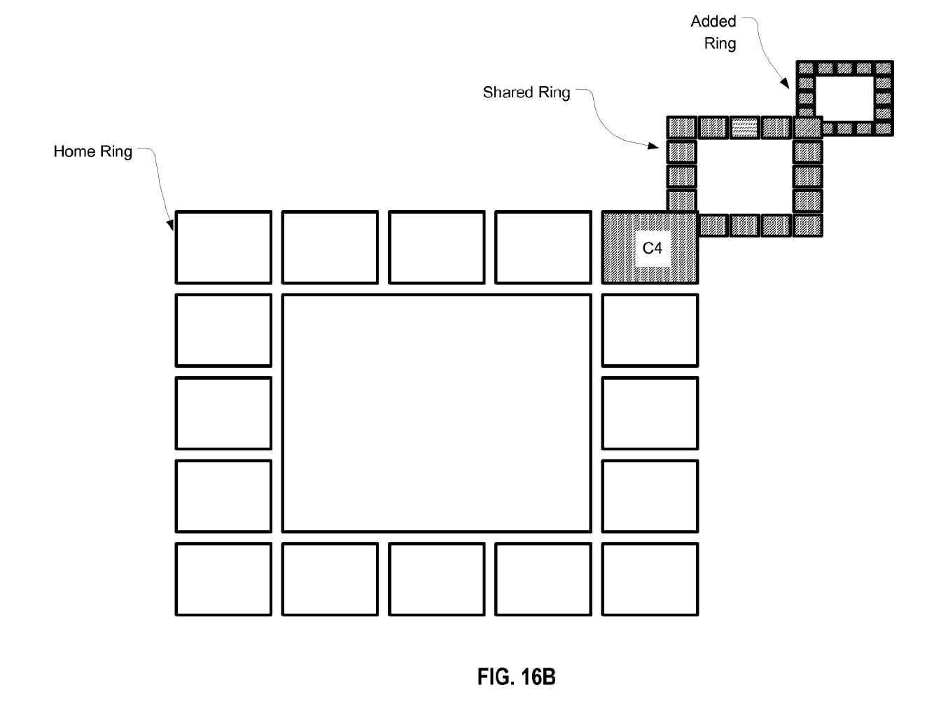

The personalization/recommendation server 218 enables users to define personal sub-Rings populated with selections of both type cells, and record cells. Personalized sub-Rings are stored in the user database 230. The personalization/recommendation server 218 also generates recommendations for media content or other available Rings, using collaborative filtering, Bayesian, or other predictive modeling methods. Third party recommendation services can connect with the personalization/recommendation server 218 through APIs. Personalization of sub-Rings is further described below with respect to FIG. 16.

The user registration server 220 creates and manages user accounts for the RingGuide hosting service 200, although in some implementations it is not necessary to have an account to view videos from the RingGuide hosting service 200. For those users who establish accounts, during account creation, users are requested to provide demographic information and a user login is assigned. The user registration server 220 stores the user demographic information in the user database 230 associated with the respective login. For users who do not establish accounts, they may be identified by the user's internet protocol address, which the user registration server 220 can store in the user database 2020.

The PVR server 221 operates as a network-based PVR, whereby users can set up preferences and schedules for recording new or existing content from any source (e.g., content distributed by other users, content providers, etc.), and for controlling playback of such selected content. A user establishes PVR settings (stored in the user's account profile in the user database 230) identifying which content is to be recorded. In one embodiment, recording does not require actual copying of a media file to the user's account in the user database (since the context is already persistent in the system or accessible thereto), but merely storing a reference, link, pointer, or other addressing information identifying the content so that it can be retrieved by the PVR server 221 when requested by the user.

The content database 222 is a storage system that includes content files uploaded by users, content providers, sponsors and advertisers, as well links to content provided by content providers 240. This server contains information on DRM and content licensing restrictions or requirements.

The user database 230 includes data on users that communicate with the RingGuide hosting service 200. An example of data included in the user database 230 for a specific user includes viewer profiles (e.g., device information, viewer preferences), as well viewing history of which Rings, and cells the user has accessed. User defined Rings are stored in the user database 230 as well. In one embodiment, a user defined Ring is stored as a collection of identifiers of assets (e.g., content files, code files, image files, etc.), and one or more links (references) to another Ring, along with information describing which identifiers and links are associated with which cells in the Ring, thereby describing the graphical arrangement of the selected content/links within the Ring. For example, in one embodiment, each Ring has a unique Ring ID, and each cell therein has a relative ID, for example corresponding to its position within the Ring. A user defined ring then is stored by associating a Ring ID, with a selection of content identifiers and one or more links to other Rings, and for each of these, a cell ID for the cell that will display the content or link. The user database 230 also stores demographic information about the user, including the user's gender, age, subject matter interests, income level, where the user lives, and/or any other demographic information. In all cases, the server functions above (and others) can be handled through APIs calling third party functions and databases without affecting the RingGuide methodology.

### III. Use Cases for RingGuide

### A. Global Media Guide

Users seeking to discover, consume, collect and share media on a television set, PC, game console, mobile device, etc. can use a RingGuide Global Media Guide (“GMG”) service provided by a cable, satellite, mobile or fixed line telephone company, consumer electronics (“CE”) device manufacturer or a web service operator.

The RingGuide GMG comprises a hierarchy of Rings displaying on one or more of these devices. The Rings may contain Asset Cells representing a database record asset available in associated local or remote databases (a movie, video or graphical advertisement, TV show, metadata, contact, etc.) as well as non-database assets such as streaming video or audio; Code Cells capable of executing specific functionality, such as search, “show by time”, a widget that displays real-time weather information or a separately launchable application such as an instant messaging client; Element Cells showing user interface elements, and Link Cells that refer to GMG sub-Rings that may be organized by genre, media owner brands, etc.

The organization of these Cells in any Ring is flexible according to the Ring's purpose, Operator's rules, and user's preferences. In a GMG implementation, certain Asset Cells can be reserved by the Operator as advertising “slots” into which ad units can be inserted. Depending on functionality, these slots may be represented by either Asset, Link, Code, or Element Cells. The size, shape, functionality and position of these “slots” within various Rings can be standard from Ring to Ring, or vary by Ring. As will be seen below, slot locations affect the value of the ad unit.

The user controls the GMG by using the device's input method (TV remote control, keyboard/mouse, haptic or positional controller, touch screen, etc.) to move a “highlight” or other focus indicator from cell to cell around the Ring. In the Global Media Guide use case, a typical TV remote control may be used, its right or left buttons moving the highlight clockwise or counterclockwise, depending on cultural norms. The TV remote control may also include a local display interface which displays a proxy interface that corresponds to the RingGuide interface on the user's display device. In such an embodiment, the proxy interface can appear identically to the main RingGuide display, or, depending on device and network capabilities, it can be a simplified arrangement of Cells, so long as the function of the proxy Cells are identical to and communicative with the main interface. The user selects a Cell by touching or gesturing on the screen directly to highlight the desired cell of the onscreen RingGuide interface.

If the User is accessing the GMG via a mobile “smartphone” or similar device equipped with a touch screen, the user also uses touch and/or gestures on the screen directly to highlight the desired cell of the onscreen RingGuide interface. Some devices, such as smartphones, can both access GMG directly or act as controller for another device on which GMG is accessed. For example, accessing GMG directly via a smartphone can be expensive depending on the user's data subscription with their mobile phone service provider. Therefore, when the user is at home, using the smartphone as a proxy interface for accessing GMG via the television is beneficial. Data usage via a home internet service provider is usually not metered and the display on a television is larger and thus the experience is richer.

FIG. 9 illustrates a proxy interface to GMG. This figure illustrates a client device, a portable media player 903, which is executing the RingGuide interface, and outputting its video content to a television 901. On the client device 903, the user has selected a video (“George Bush pardons the turkey”) to be displayed full screen. The video is shown on both the display of the client device 903, as well as on the television 901.

The Ring provides a method by which user's can dynamically discover content in an automatic, contextual manner. When a Link Cell is highlighted, the current Ring's Content Window automatically displays the previews (and optionally metadata if available) of Assets in referenced sub-Ring. The order in which the sub-Ring's content/metadata is displayed can be controlled algorithmically and modified by the Operator, but the default order is to show content and metadata associated with each cell of the referenced sub-Ring sequentially, moving automatically clockwise or counterclockwise around the sub-Ring depending on system configuration. This automatic, sequential preview mode exposes users to media content/advertising in a programmable manner, enabling the creation of a variety of integrated and hierarchal promotional and advertising schemas.

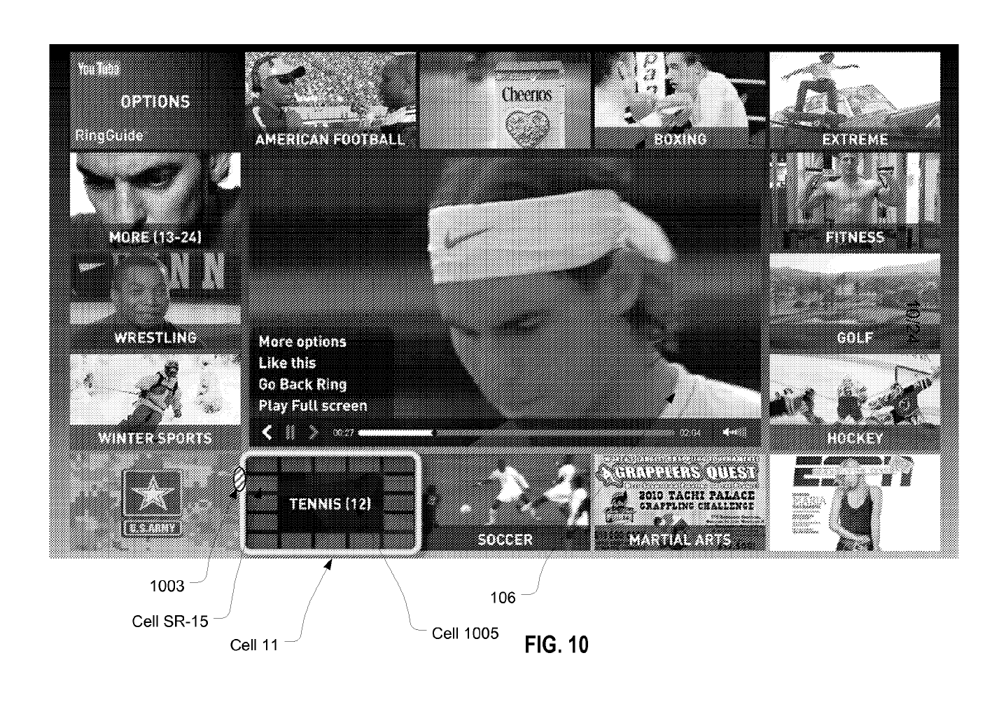

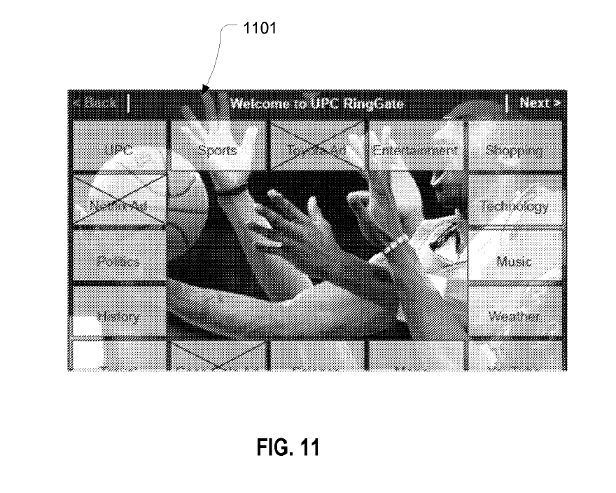

FIG. 10 illustrates an example Ring in the GMG. Depending on the type of Cell selected, the Content Window 106 display changes. For example, if an Asset Cell representing a movie is selected, the Content Window 106 displays a movie trailer preview and its metadata (if available) of the Asset represented by the selected Cell. If the user presses the remote control's Play button (or touches the Content Window 106) while watching the preview, the movie asset itself begins to play full-screen. If, while the movie is playing, the user presses the Stop button (or touches the full-screen display), the display reverts to the Content Window 106, with the movie's trailer playing again, preferably at the same point. Skip forward, skip back and other common features are supported by Element Cells and/or the hard-coded buttons on the system's remote control, etc.

The Content Window and full-screen display modes can display combinations of metadata, graphics, motion video, sound, etc. The sequence of these media types can be presented with interspersed advertisements (such as pre-, mid, and post-roll video ads) inserted by the RingGuide Operator, using third-party or Operator-owned ad insertion services.

If a Link Cell is highlighted, the Content Window displays previews of the Cells in the Ring to which the Link Cell links (“Linked Ring”). In FIG. 10, the highlighted Link Cell, Cell 11 has tennis-related content. Cell 11 is highlighted and so the various assets in the sub-Ring to which Cell 11 links are being shown. A second highlight 1003 that is visually distinct from the overall highlight for Cell 11 indicates that the fifteenth Cell of the sub-Ring, Cell SR-15, is currently being displayed in the Content Window 106. This allows the user to more quickly locate that Asset in the Linked Ring if the user chooses to go to the Linked Ring. To further assist the user, the graphical representation includes the number 1005 of Cells in the Linked Ring. In this example that is 12. If the Linked Ring includes Overflow Rings, the number 1005 displayed includes all Cells in all of the Overflow Rings as well as the Linked Ring. Should the user select a Link Cell, the sub-Ring opens with the cell highlighted which was being previewed at the previous level. In the example of FIG. 10, the sub-Ring for Cell 11 opens with Cell SR-15 highlighted because that is the Cell currently being previewed. Additionally, the Content Window 106, which is playing Cell SR-15 when the user selects Cell 11, does not change. The preview of Cell SR-15 continues to play as the ring around it changes to the sub-Ring.

If a user is not actively engaging with RingGuide, RingGuide goes to a passive browsing mode. Each asset in the Ring is highlighted in turn and the content of the Content Window changes accordingly. When a Link Cell is highlighted, the passive browsing goes around the sub-Ring to which the Link Cell links. The amount of idle time required before RingGuide commences passive browsing can be set by user preferences or business rules. Similarly, the amount of time spent on a single Cell before moving to the next one can also be set by user preferences or business rules.

Referring to FIG. 11, another embodiment of GMG is illustrated. When a user is watching a program on television and invokes RingGuide, RingGuide can appear as a translucent overlay over the television show so that the television program is not completely obscured. In such an embodiment, Cells are minimalist in appearance with just text used to identify their content.

Ring to Ring transitions are preferably, but not required to be, the same within a use case. Referring still to FIG. 11, in one embodiment of the GMG instantiation, an “eyebrow” graphic 1101 appears at the top of each Ring when the Ring is first presented. The eyebrow contains a textual description of the Ring's name centered between two Element Cells, “Back” and “Next.” Alternatively, the functionality of the “Back” and “Next” elements are provided by a picklist menu.

GMG provides users with a search function in the form of a Code Cell or as a picklist menu item. Upon selecting the search function, a Search Ring with onscreen keyboard is displayed. The Search Ring enables alphanumeric entry to search available assets, preferably on local and remote storage media and databases inside and outside the Operators' systems(s). While entering alphanumeric characters to parse available assets, the user can select various criteria by which to search available assets. Operation of this search function can be combined with Code Cells that when focused, effect on-screen parsing of available results returned by the search entry criteria.

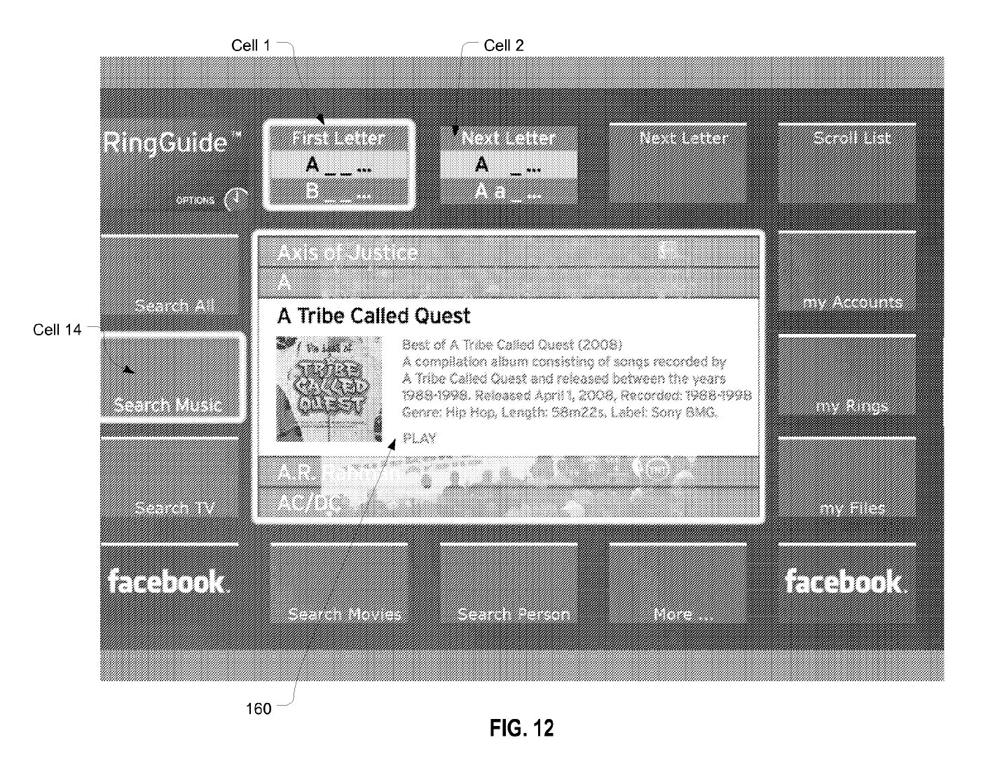

FIG. 12 illustrates Code Cells for searching. A user has searched for music using the Search Music Cell 14. The results are displayed in the Content Window 160. The user has used Cell 1 to search for music by artists whose names start with “A.” The results in the Content Window 160 show only those that start with “A.” The user can further refine the search by specifying the second letter of the artist's name using Cell 2. In an alternate embodiment, search results are displayed in one or more Results Rings, with relevant advertising displayed in reserved Cells.

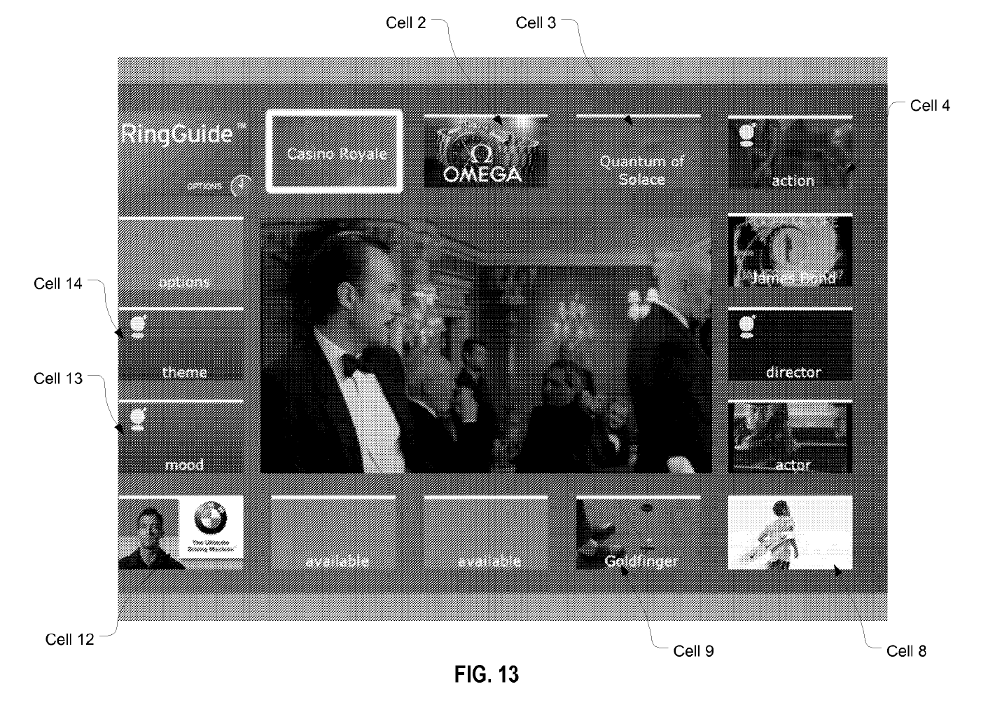

In addition to user-defined single searches RingGuide, enables a method of secondary simultaneous multiple searches (SMSS). This provides an automatic extension of the user's content choices, presented in a consistent manner. These simultaneous searches can use pre-defined, conditional, random, or a mixture of these criteria. One example of SMSS is illustrated in FIG. 13. A user is watching Casino Royale and has selected “More Options” from an onscreen picklist menu. The RingGuide system simultaneously searched multiple queries and presented this screen, using metadata for “Casino Royale” as the search context.

Cell 3, a Record Cell, shows the single result, “Quantum of Solace,” of a search using the pre-determined query “<same movie catalog> AND <same starring actor> NOT <current movie>.” Cell 4, a Link Cell, links to a sub-Ring containing the multiple results of a search using the predetermined query “<action> AND <movies>.”

Cell 9, a Record Cell, shows the single result, “Goldfinger,” of a conditional search on the query “<James Bond movies> AND <movies released when current user was between 18-35 years old> AND <movies containing scenes> EQUAL TO <sporting event type most collected by current user>.”

The “Theme” cell, Cell 14, and “Mood” cell, Cell 13, are examples from a library of different Code Cells for filtering displayed results. The user can select and include these filters in a “More Options” search. Theme and Mood use scene-by-scene analysis of metadata (using functionality and metadata provided by third-parties or RingGuide), to search for similar scenes in other assets available within RingGuide system. The search results are then presented in sub-Rings linked to these Cells. RingGuide enables users to create their own search criteria (set using the “Available . . . ” Cells) and control the inclusion of their personal information in conditional searches. Random searches like “I Feel Lucky” can also be included by users during Search options set-up. Cell 2, Cell 8 and Cell 12 display advertisements that are context-specific to the movie Casino Royale. Omega is a brand of watches associated with James Bond movies, as is the BMW car brand. The BMW ad portrays the actor Daniel Craig who plays James Bond in Quantum of Solace and Casino Royale.

A further enhancement of the secondary simultaneous multiple searches method is RingGuide's ability to automatically execute a subsequent SMSS for related or recommended items based on each of the returned results of the first search. In this manner, even searches that result in a single returned item (which would thus be represented by a Record Cell) can be automatically followed by a search that populates a sub-Ring of related items (the Record Cell then becoming a Link Cell), thus deepening the user's discovery experience.

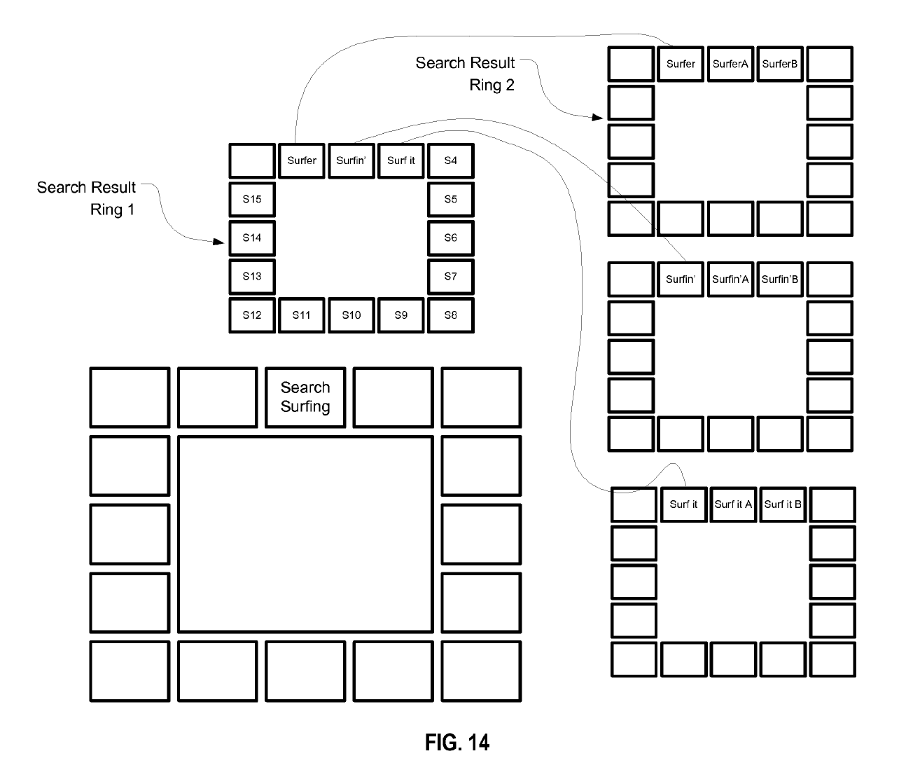

An example of the SMSS method would be a user searching for “surfing.” As illustrated in FIG. 14, a set of fifteen records are retrieved, Surfer, Surfin', Surf it, S4 . . . S15, and displayed in the Search Result Ring 1. For each record, there is a sub-Ring which is created by a SMSS search for records related to the first search result. The first cell in each such sub-Ring is the cell on which the search results were generated. Thus, Surfer is a Link Cell in Search Result Ring 1 to a Search Result Ring 2 of records that are related to Surfer, and Surfer is the first cell in Search Result Ring 2 as well. In one embodiment, when linking down to the sub-Ring for Surfer, Surfer is the first record in the sub-Ring followed by 14 records, SurferA, SurferB, etc that are related to Surfer.

In one embodiment each of the SMSS queries is executed and underlying sub-Rings are populated with the search results, each sub-Ring linked to their respective Link Cells. The results in each sub-Ring are then available as previews in the Content Window, using the previously described preview operations.

SMSS queries can be configured by the system operator, set by the user who can create and save their own queries based on their interests, or run against predefined search critieria provided by the content provider, for example YouTube's “related” search.

### B. Rings of Dynamic Content

The contents of cells of a Ring can be dynamic to display continually changing content. Here, the Ring content is not known a priori, but is selected based on contextual information about the content of other rings. The previously described Rings created from searches are one example of Rings containing Dynamic Content. Additional examples of content that lends itself to Rings of dynamic content include submissions of user-generated content, and continually accruing assets such as live video streams or repeating MRSS/RSS feeds. Additionally, recommendation engines can suggest groups of other items that may be of interest to the user based on the user's indication of interest in a specific item. These dynamic contents are grouped in one or more categories linked to the item without predefined labels or hierarchal relationships. These dynamic item sets are collected and organized in dynamic Rings.

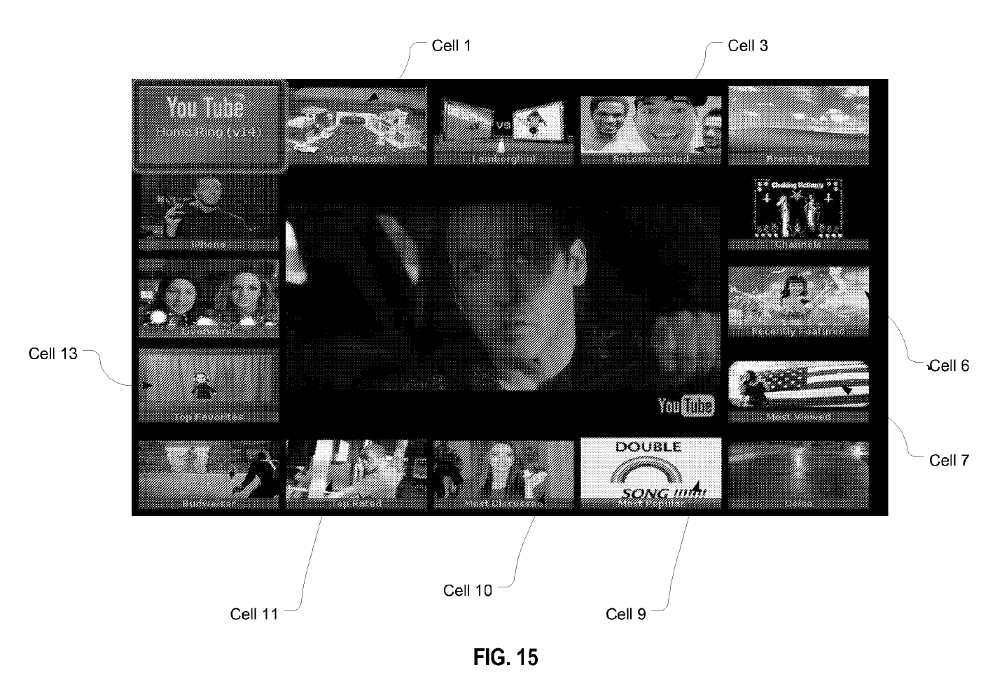

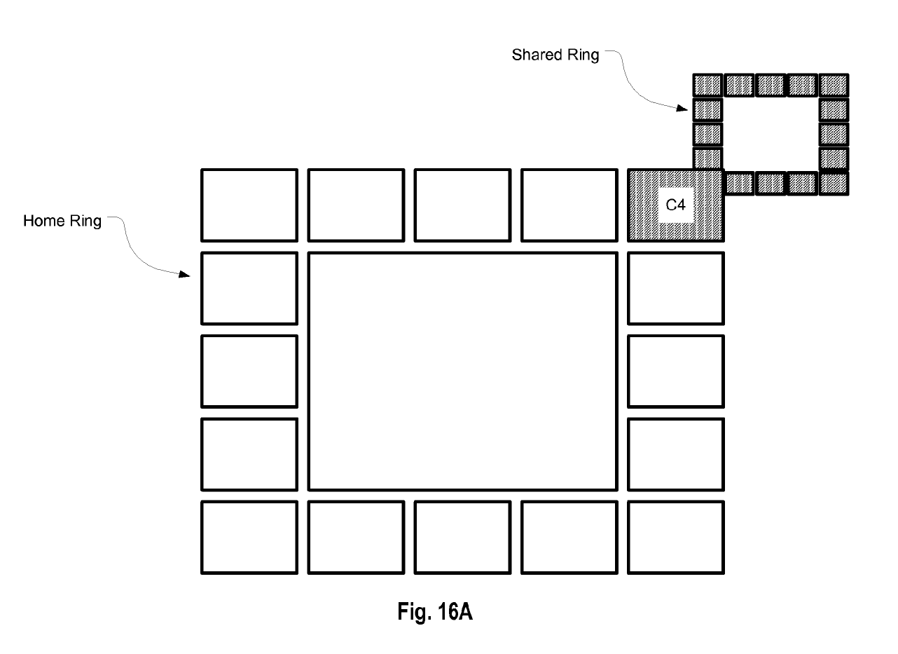

Another example of a Ring populated dynamically is a Ring containing content that of what is most popular with other users. Cells in one or more Rings that link to the most popular or most watched content, or most accessed Rings. FIG. 15 illustrates such a Ring. Link Cells include Cell 1 for “Most Recent” content, Cell 3 to “Recommended” content, Cell 6 to “Recently Featured” content, Cell 7 to “Most Viewed” content, Cell 9 to “Most Popular” content, Cell 10 to “Most Discussed” content, Cell 11 to “Top Rated” content, and Cell 13 to “Top Favorites.” Additionally or alternatively, the default Home Ring includes one or a few Link Cells to Rings of popular content. RingGuide determines which content to include in each category using component attributes such as Ring content sources, types, metadata, scene(s) within content and user attributes like social rating and sharing history, current/historical behavior, preferences, social relationships, and demographics (the user attributes collectively called social psycho-demographics).

Users can also automatically import content, contacts and other data from third party services. The RingGuide system operates as a normalizing interface and organizational structure for multiple content sources. RingGuide automatically imports content and contacts lists from web services like YouTube, MRSS feeds like Discovery Channel, and other content services using publicly available application programming interfaces (APIs) and standard token-based services like OAuth 2.0. The imported content is organized automatically into a plurality of Rings, with individual content items assigned to Asset Cells, and then assigned to Rings based on the attributes of the content, such as category information, titles, names, or the like. Overflow Rings are used where appropriate to handle excess numbers of content items. After creating the relationship between a user's RingGuide and the third party services, changes made at the third party services' site are synced to RingGuide.

Given a Ring with focused Link Cell linked to a sub-Ring of dynamic content, previews in the current Ring's Content Window will be for the dynamically populated records (e.g., a set of 12 or more shows, videos, etc.) contained in the currently focused Link Cell's sub-Ring. When the user selects the focused Link Cell, the resulting Ring will contain a set of Link Cells, headed by the records that were in the previews, but with dynamically created sub-Rings created by automatic simultaneous searches which populated the new sub-Rings with content associated with each record. Thus the current Ring is now comprised of Link Cells, each of which links to a sub-Ring, whose contents include the record cell itself and “related content”, e.g., related videos. Maintaining the preview as a Record Cell, then as a Link Cell provides context when traversing through the rings.

### C. RingGuide Management of Webpage Content

In an embodiment where a RingGuide enabled client device has a web browser, the Ring architecture integrates viewing of web pages within the Ring. Depending on the application/service design, individual web pages may be presented as Asset Cells, with the webpage related to the focused Cell displayed in the Content Window as a web page with full web interactivity (e.g., active hyperlinks, Java application execution, Flash support, and so forth). “Up” and “Down” arrows, gestures, etc. can be used to focus actionable objects within the previewed webpage), and pressing a remote control button, or touching the device's touchscreen, etc., on the highlighted link can execute the HTML, Javascript, Flash, or other commands that are native to the specific webpage. Pressing another button or other input can summon a full screen display of the webpage, with further user input as supported by the device's browser. This embodiment can contain the native webpage's existing advertising elements and relationships.

### D. Personalization and Sharing of Rings

Subject to rules established by the Operator, content rights, and permissions set by the Ring creator or recipient, and other conditions, users can share pre-programmed as well as personalized Rings and Ring Collections across one or more networks. Recipients of a Ring or Ring Collection can then modify and send the modified Ring or Ring Collection to others. Additionally, recipients can append Rings or Ring Collections onto received Ring(s) and Ring Collections share the updated Rings or Ring Collections.

Through sharing RingGuide thus enables a new individual role, one that has been traditionally held by large media businesses known as “Network Programmers” or “System Operators.” Users can shape the viewing and user experiences of their friends and even larger audiences. Those Ring creators who are most skilled at creating and promoting compelling Rings will become independent network programmers whose audiences will watch Rings rather than watch “channels.” The ability to organize content into Rings and Ring Clouds make possible unique contextual and structured relationships between content assets in a way that extends and enriches the typical linear “playlist”, “CD” or “album”. The modularity, extensibility and consistency of the Ring architecture enables a new kind of shareable medium.

FIG. 16A illustrates an example of sharing of Rings. A first user may create a Ring of personal favorite videos and share that with a second user. The second user's Home Ring is shown with a Link Cell C4 to the Shared Ring. FIG. 16B illustrates the second user having modified the Shared Ring. One of the cells in the Shared Ring is now hierarchically linked with an Added Ringcontaining some content selected by the second user. Added Ring can be part of said second user's Ring Collection. Shared Ring and Added Ring are a new Ring Chain. The second user could then send the new Ring Chain to a third user. The third user could then further populate the Added Ring of the Ring Chain, and hierarchically link yet a third Ring to the Added Ring, extending the Ring Chain, and so on. Subject to user preferences, applicable laws, and Operator rules, Operators can send Rings or Ring Chains to users or groups of users. This media Ring creation is for example only, and users' ability to create and share Rings can be used for many purposes, including the extension of system functions, creation of new applications, and the like.

Rings can be shared between Ring users in various ways and are automatically stored in the Ring sender's and Ring recipients' “Shared Rings” Ring, which by default is linked to the default Home Ring. During a Ring session, the contents of the sender's and recipient(s) “My Shared Rings” sub-Ring (which is by default linked to the user's Home Page, though this can be modified by the user) are updated by the session server 204 with a RingID of the shared Ring. When this RingID is requested by the recipient, the Ring is served by the Ring server 216, displayed on the requesting device and controlled normally, using device-specific inputs.

When a Ring is shared to a device capable of playing the shared Ring with full functionality the shared Ring will be displayed with full content and functionality. A typical example is in a “lightboxed” or pop-up HTML5-compliant browser session viewed on the requesting device. In some cases, a service- or device-specific application (“app”) will be required to view and use the shared Ring. This app will be served by the application server 202.

Rings can also be shared outside a Ring system. In one embodiment the RingGuide server service that creates a graphic Ring Snapshot of a Ring and includes active links associated with each Cell thumbnail. The Ring snapshot can be embedded in email, instant messages, webpages, WAP pushes, and other HTML-aware transport mechanisms. The RingSnapshot service running on the ingest server 214 creates a snapshot of the shared Ring. This snapshot includes a JPEG, PNG or similar image of the Ring itself, hashed links from the global name server, a map of each Cell's link as an overlay to the graphic, a link to the RingID, and associated metadata (this metadata can include thirdparty metadata, sender's comments, or social media data such as ranking, etc.). This snapshot is stored in the content database 222 and linked to the user's account in the user database 230. The Ring snapshot, link overlay, and metadata are served to services (e.g., Facebook) that do not support full Ring playback functionality. If the requesting playback environment supports multiple HTML links, all cell links in the overlay are active, and can be clicked to launch a Ring browser session in another window, outside the requesting environment. In environments that support only a single HTML link with graphic, the recipient's request will launch the shared Ring in a separate browser session.

When the recipient clicks on the Ring snapshot the operable Ring is served by RingGuide in a device-appropriate viewer. If the recipient environment supports multiple HTML links, the Cell on which the recipient clicked, will be in focus and its preview playing when the Ring is served.

If the device to which a Ring is shared does not support graphics but supports an HTML link, such as SMS and Twitter, the notification, metadata, and link are shown on the recipient's device. When the user clicks on the link or metadata, the request is served by the ring server 216 to resolve the ring ID, and the current instance of the ring is provided back to the client if viewable.

The above descriptions describe asynchronous sharing of Rings. The RingGuide system supports synchronous Ring sharing as well. A benefit of the RingGuide system is the personal nature of shared Rings. Ring users can create Rings to share synchronously with friends. These Rings can include collections of content, such as television programs, or live streams such as videoconferences. A typical use case might include “viewing parties” where multiple Ring viewers in different locations can watch and comment on several sporting events simultaneously. Content can be selected by one creator, or democratically by viewers who vote to place specific content in particular Cells. These real-time Rings are assigned a RingID that can be shared to participants by the Ring server 216, then the content is processed by the ingest server 214, and managed by the front end Server 201 and session server 204.

When shared, the RingID of the shared Ring is saved in the content database 222 and linked to the sender's account in the user database 230. A global name space mechanism creates a hashed unique name for each link of the shared Ring and its first-level sub-Rings. The name space mechanism's hashing algorithm is a combination of a global/local name space URI, source name, time stamp etc. Not all indexing can be against a global name space as there are relationships that map to other RingGuide states that are derived from users' social psycho-demographics, events, time range, popularity etc that forces a specific hierarchy to the content cluster from an organization perspective. The RingGuide hierarchy is a network where references are both global and local and thus name spaces are both global and local. These names can be “frozen” to preserve the shared Ring links at the time of creation, or automatically updated as explained below. A “time-to-live” value is set for the shared Ring and its first level sub-Rings' links and stored with the RingID in the content database.

A notification is sent by the front end server 201 to shared Ring addressees. Registered addressees of the shared Ring are stored in user database 230. Unregistered Ring addressees are stored in the user database 230 as unregistered users associated with a specific device identifier, cookie, IP address, etc.

In some embodiments, the RingGuide service uses URI links to content. These links may be ephemeral. Since expiration of these links or changing of content associated with these links can affect Ring users and recipients, the RingGuide system enables various levels of “time-to-live” expiration quality-of-service (QOS) levels. For example, subject to content rights agreements and digital rights management capabilities, the operator of a RingGuide service can store content that is related to links in the Ring content server or can regularly update/verify links and provide archive and link maintenance services to for a fee. These services run on the ingest server 214 and Ring server 216 and results are stored in the content database 222.

### E. Ring World Income Generation

The RingGuide system provides tools for independent “network programmers” (Ring and Ring Collection creators) to create and promote their Rings and earn income for their work. Ring creators can use the ad system to promote their Rings to users across various Ring World networks.

Ring creators can earn income by sharing with the RingGuide service a percentage of advertising or sponsorship revenues earned by their Rings, by selling user-created Rings in an ecommerce store (the “Ring Market”) managed by the RingGuide Service or operators, or a combination of these and other revenue models heretofore generally practiced by larger businesses.

Because Ring creators are now “programmers,” they may wish to promote their Rings to others. Operators can enable creators to participate in the RingGuide ad marketplace, creating, bidding for, and inserting their own promotional messages into reserved Cells. This ability of users to attract audiences, earn money, recognition, credits or other value from their Ring creations, and the derivative works of others, is another benefit of the RingGuide methodology. This benefit has a further viral effect, in that as more electronic devices make use of the RingGuide as their user interface, the desirability of using the RingGuide increases, as do the potential numbers of users who both consume content, and share content via their Rings. The more consumers share Rings, the more revenue operators will obtain over the long run.

DEAP™: Distributed Exponential Advertising Platform

RingGuide's Distributed Exponential Ad Platform is a powerful system for Ring creators, advertisers and sponsors to communicate messages and offers to RingGuide users. Messages, ads and sponsorships can be presented as:
1. “static banners” (a static display of a graphic appears in an Asset Cell and associated metadata, graphic, animation or video asset plays within the Content Window when the Asset cell is focused, whether actively by the user or in “passive browse” mode)
2. “animating” or “video banners” (an animation or video clip plays in the Asset Cell and its associated metadata, graphic, animation or video asset plays within the Content Window when the Ring cell is focused, whether actively by the user or in “passive browse” mode),
3. “pre-, mid-, and/or post-roll video ads (a video advertisement or message is inserted in Content Window or full-screen playouts)
4. “Chained Ads” (inserted into reserved Cells within RingChains distributed across one or more networks)
5. “Search ads” (appearing in Rings presented to users as the result of a textual search).
6. “Interactive ad units”, generally (but not limited to) a broad range of web-based “click to call”, “click to order”, and other functions, displayed as Code Cells within the RingGuide methodology.
7. Sponsored Rings or RingChains, wherein an advertiser or sponsor can brand and program a portion or entire Ring/RingChain with their content (e.g. the Tiffany Wedding Ring of lifestyle products and services, the Audi Nuremberg Ring of motorsports content, the Viacom Rings of MTV, Nickelodeon, Showtime, etc. content.
8. Operator/Service branding, wherein an operator can pay to create one or more unique visual branding treatments within the Ring methodology.
9. Landing Pages, in which a content owner can create and control the Ring(s) displayed to a Ring user when playing the content requested from the content owner.
10. Blends of all of the above.

Ad Pricing

Pricing for advertisements and sponsorships within the RingWorld system can be determined in many ways. These methods can be determined by the system operator or Ring creators. In a simple embodiment, pricing can vary depending on its location in the RingGuide hierarchy in terms of its depth (number of Rings down from the Home Ring) and its location within a ring (placement location). In more sophisticated embodiments, pricing methods can be highly complex, with the RingGuide system determining value based on a user's psycho-demographic data, whether the ads appear in user- or system-created Rings, identities of ad-bearing Ring senders and recipients, how many times these Rings/ads were shared, the relative proximity of other contextual content, etc. These RingGuide-specific capabilities are discussed more fully below.

In today's websites, advertisers can buy multiple placements on the same page, and can buy multiple ad types: graphic “banners” and “skyscrapers”, full motion or animating video cells, video pre-, mid-, and post-rolls or video “pop-ups” overlays. But unlike today's websites, RingGuide makes possible the creation of deeply organized ad buys, supporting multiple ad buys on a single Ring, within multiple Rings, mixtures of banners, skyscrapers, video cells, interstitials and pop-ups within previews and content on different or the same hierarchal Ring levels, and in shared Rings and Ring Chains, all within a single consistent framework and optimized by analyzing the continuous dynamic feedback of users' and shared Ring recipients' behavior within ad-bearing Rings.

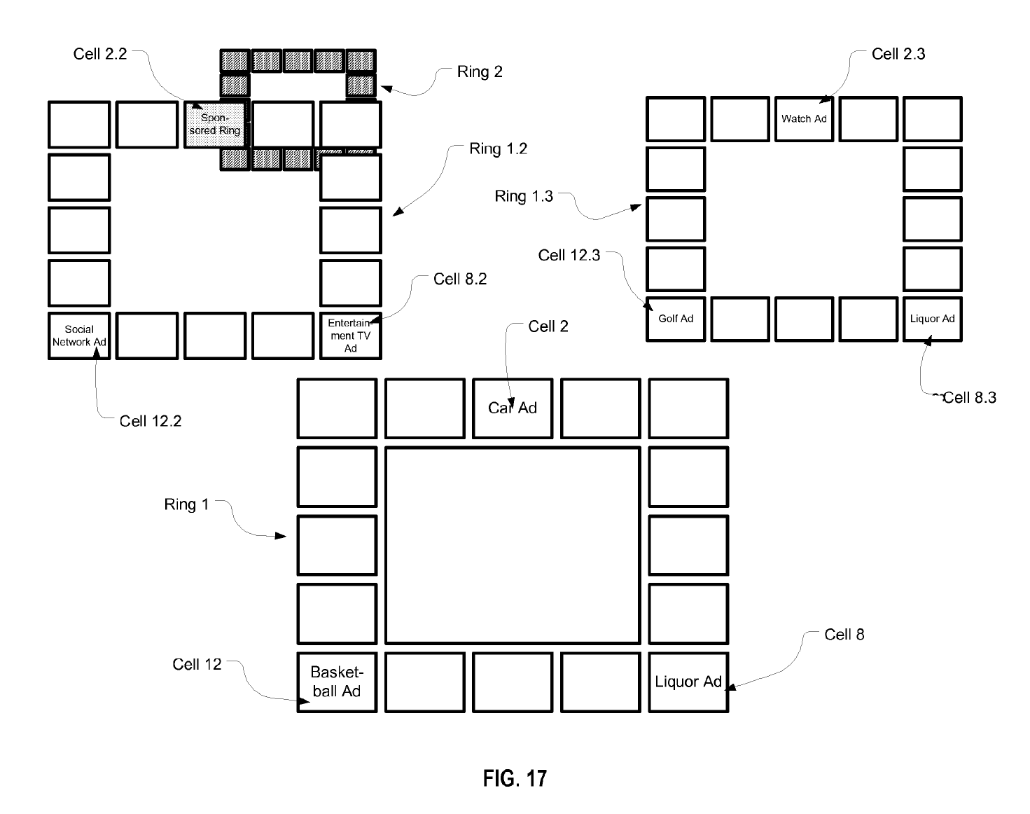

Rings can contain advertisements in one or more reserved Cell positions (as well as other locations). Ads in Ring cells and their positions can be persistent when the Ring is shared. These shared ads may be addressable by RingGuide or third-party ad servers, and ads or their positions within the Ring can be changed based on the Ring recipients' characteristics and other factors. FIG. 17 illustrates personalization of ads as Rings are shared. User 1 has created Ring 1, a basketball-themed sports Ring. User 1 is a 25-40 year-old male, in an urban zipcode and the average household income in the neighborhood is over $100K/year. The ads selected for display to User 1 based on this information are a car ad at Cell 2, a liquor ad at Cell 8 and a basketball ad at Cell 12.

User 1 shares ring Ring 1 with User 2 and User 3. Ring 1 is transformed with advertising specific to the user with whom it is shared, becoming Ring 1.2 for User 2 and Ring 1.3 for User 3. User 2 is an 18-25 year-old female, lives in a zip code in Nashville, Tenn. and has created country-music themed rings in her own RingGuide. The ads selected for User 2 are a link to a sponsored music ring at Cell 2.2, an entertainment TV ad at Cell 8.2 and a social network ad at Cell 12.2. The sponsored ring, Ring 2, is created by a country music publisher. User 3 is a 40-55 year-old male, in a suburban zip code and the average household income in the neighborhood is over $65K/year. User 3 has previously “Liked” golf videos. The ads displayed for User 3 include a liquor ad at Cell 8.3. This may or may not be the same liquor ad displayed to User 1 at Cell 8. The additional ads for User 3 are a watch ad at Cell 2.3 and a golf ad at Cell 12.3.

Because Ring content and advertising is dynamic in responsive to user behavior, sharing, preferences and other factors discussed in the section on analytics, it has a personalized context. This context increases the value of advertising in the Ring.

When these Rings are subsequently shared, their content and advertising can be further modified by the RingGuide system on the basis of the recipients' behavior preferences social/psychodemographic characteristics and other factors. This new context further increases the value of advertising in the shared Rings.

Ring sharing increases the “reach”, targetability and precision of RingGuide advertising. RingGuide represents a dynamic multi-dimensional closed loop system whose value increases exponentially as Rings are shared and social/psychodemographic and behavioral context is measured.

Creators, advertisers and sponsors can vary their message, advertisement or offer specifically in response to data gathered from the Ring or RingChain so as to maximize the relevancy of these ads to a particular user. The gathered data (“analytics data”) can include user registration, profile and activity information from connected social networks, user behavior including Ring creation, modification, deletion, sharing, “liking”; creation and sharing of RingChains, and other activities. This approach enables advertisers and sponsor to leverage both the user generation of content and structure, as well as user sharing of content and structure, in a manner that far surpasses conventional advertising which is merely placed alongside user generated content, for example on conventional video sharing sites. Additionally, the richness of the LEAP relationships makes possible a sophisticated analysis of results and tuning of ad campaigns to maximize effectiveness.

RingGuide's consistent structure, cellular addressability, personalization and social capabilities, contextual search, and default passive browse mode enable rich methods of targeting audiences, analyzing ad performance, and optimizing pricing.

RingGuide allows for optimization of placement of ads in relation to the content of other Cells in the Ring. The advertiser can place their ad adjacent to a specific content item that can be shown from its social attributes (the number of times it was “Liked” by the advertisers' desired audience), its hierarchal position(s) and frequency of inclusion in the user's personalized Rings, its source attribute (from a network with whom the advertiser currently buys or whose audience is particularly valuable), from whom it was shared if included in the user's Shared Rings, and the number of times the content was viewed to its end. Further, an advertiser can control the display of their ads on the basis of the particular scene within a preview or the content. These factors are weighted to yield a value for the advertiser's purchase of a particular Cell location, preview or content interstitial ad, or sponsored Ring.

In addition to deciding whether to be adjacent to a piece of content, an advertiser can choose to advertise one or more Cells or one or more Rings away from a piece of content. This is multi-dimensional adjacency. For example, if the price to advertise immediately adjacent to the content Cell is too high, the advertiser can advertise one or more Cells away from the desired content on the same Ring, closer or farther from other ads or content, or can buy positions in “lower” levels of the Ring hierarchy, priced by the probability the ad will be seen during passive browse or by the user when navigating from their current Ring. Advertisers can choose only to advertise on Rings that are shared by or to certain users, or groups of users, or purchase blended buys across these dimensions.

Analytics

RingGuide's can provide advertisers with many details about the performance of their ad and actions around their ad. Examples include: what other ads were shown; which of these was watched by the Ring viewer or other Ring/Ring Chain recipents; what type and number of Cells were chosen by the user or recipients; how long they lingered on a RingCell; which of the advertiser's previews were watched; which content was viewed fullscreen; what Cells, previews and content were not viewed; the current location of the Ring user and the time a specific Ring or asset was used; and what was shared or “Liked.”

RingGuide analytics are designed to be fractal, scaling across multiple networks in a consistent fashion. RingGuide's data collection components and analytics tools are fractal as well, designed for use within Ring networks hosted by RingGuide and those operated by third-parties. This inter-network data will be used to enhance ad performance and content uptake, and will be published to network operators, advertisers/sponsors, and other customers.

RingGuide's structural consistency is an improvement over the ambiguity of heterogenous webpage structures and random navigation from data analysis and ad pricing, and its ability to scale these benefits across networks is intrinsic.

The RingGuide media methodology does not require the creation of specialized ad assets or systems operators, advertisers or agencies. Instead, RingGuide natively supports automatic insertion of standard or HD video ads (e.g. 10, 15, 30 second spots) and standard Internet Advertising Bureau (“IAB”) ads as Assets. Ad insertion and sales can be managed by third-party or Operator owned systems such as Google's DoubleClick's DART Ad Exchange, SeaChange International's AdPulse VOD ad servers, Comcast's Spotlight, etc.

Advertising can be turned off by an Operator in markets where it is not desirable or in exchange for a payment, subscription, loyalty program, or other value. Ad display may be made user selectable, depending on Operator rules, and regulatory requirements.

The ability to insert advertising at various positions within a Ring and at various Ring “depths,” to position Asset Cells within a sub-Ring so that their asset plays earlier in the automatic “passive browse” sequences (thus “bubbling up”, or promoting, content from lower levels of the Ring hierarchy to expose their content or functionality within the higher level Ring currently viewed by the user), and the ability to associate relevant advertising within related content and in response to user demographics, behavioral analytics and preferences enables Operators to sell advertising units of varying value in a manner that goes beyond traditional advertising metrics of “reach,” “frequency” and “relevancy.”

Sponsorship

Advertisers seeking to create a customized, controlled direct marketing channel to RingGuide users can create sponsored Rings, with sponsor selected (or created) Cells of any type, including Code Cells that execute specific functionality (e.g., a product configurator, selection of content for specific cells, surveys, access to other sponsor content, e.g., sponsor website, etc.). Cells in the sponsored Ring can be automatically created based on content in other Cells and other Rings (e.g., context sensitive to content). For example, a Ring sponsored by a music company is populated with recommendations for users drawn from that company's artists based on data collected about that user that are relevant to the user's music interests. RingGuide determines audio and video content played by the user to identify music artists. RingGuide determines not only audio and video content played using RingGuide but also played using other applications and other devices belonging to the user. For example, if a user is operating RingGuide on a smartphone on which they also listen to music via a music player, RingGuide determines the music playing on the music player. This information is entered into a customized algorithm running on the RingGuide service to populate a sponsored ring for the music company comprised of the identified artists and recommendations for additional music based on the identified artists.

The RingGuide System Operator can sell positions within Cells reserved for ads that link to sponsored Rings. These Cells linked to the sponsored Ring can be identified with the sponsor's name, brands, or other elements and can be graphical or include multimedia.

Separately, a sponsored ring can be selected by users for inclusion into their own ring collections. A user can intentionally share a sponsored ring directly to other users, or can share these as part of a Ring/RingChain they create, modify or share (wherein the sponsored Ring is linked to the user's selected RingCell). Depending on business arrangements, sharing users can share advertising revenue, rewards, credits, social recognition, etc. with the sponsor or RingGuidesystem operator.

RingGuide enables several methods for how sponsored Rings, or shared Rings that include sponsored Rings, appear on a recipient's Ring, including:
1. the original sponsor, content and position is identical to that on the sending user's Ring; and
2. the original sponsor remains the same, but the sponsor's content or position is modified based on the recipient's social/psychodemographics and behavior. (e.g., the Music Company Finder ring would update based on the music content in the recipient's rings and might be linked to the recipient's My Music Ring).

The sponsored Ring can be changed to a different sponsor, based on analytics of the recipient's characteristics.

Social/psychodemographics, behavior, and other characteristics of sponsored Ring senders and recipient(s) are tracked by RingGuide or third-party advertising and analytics mechanisms and used to improve ad performance, user satisfaction, and ad/sponsor pricing.

### F. Additional Use Cases

The RingGuide methodology is useful for a wide variety of other functions beyond media discovery, collections and sharing. For example, the methodology can be used in a social or business-to-business context as the organizational method for multi-party conference calls, chat sessions, etc. An example implementation would be to show individual participants, either using textual labels, avatars, photos or full-motion video depending on system capabilities, in individual Person Cells, with the active participant's subject matter materials in the Content Window. In one embodiment, the participants have uploaded content to share with the other participants. The viewer has the ability to “skip” from materials to materials or select one and make its contents appear full-screen. Alternatively, the participant presenting shows content in the Content Window.

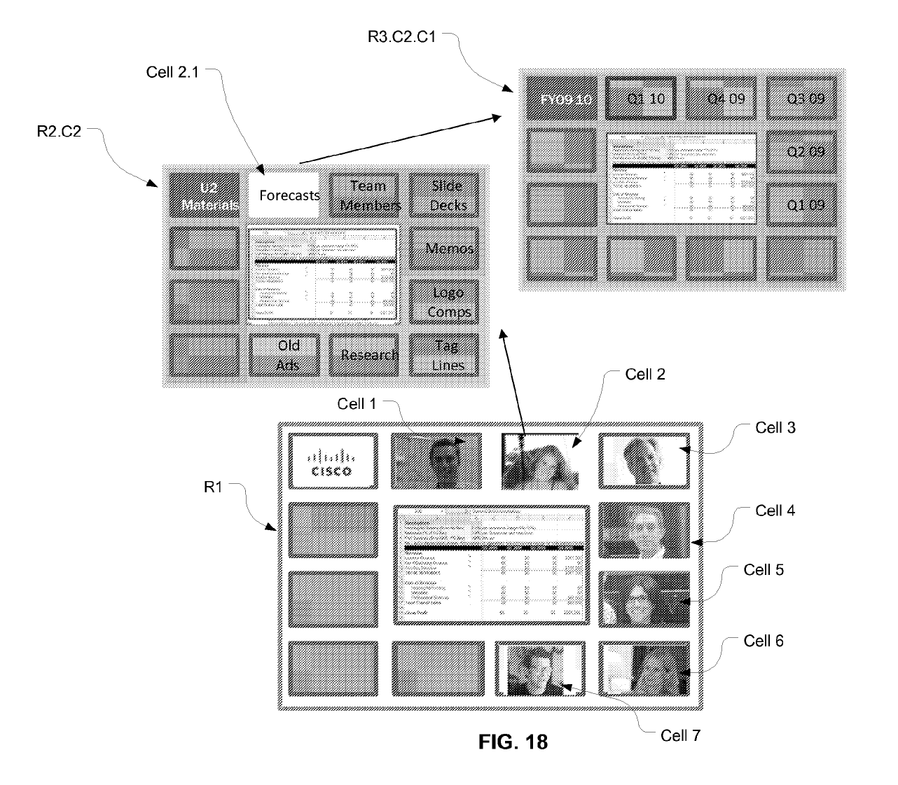

FIG. 18 illustrates an implementation of RingGuide used for video conferencing. Ring R1 is the interface for the video conference for a user. Cells 1-7 portray participants on the video conference. For participants on the call who have presentation materials to share, their Cell is a Link Cell to a Ring of such materials. For example, User 2 Cell 2 has a number of materials which are displayed in sub-Ring R2.C2. The cell labeled “Forecasts,” Cell 2.1 in turn is a Link Cell to a sub-sub-Ring R3.C2.C1 of the materials that are the Forecasts.

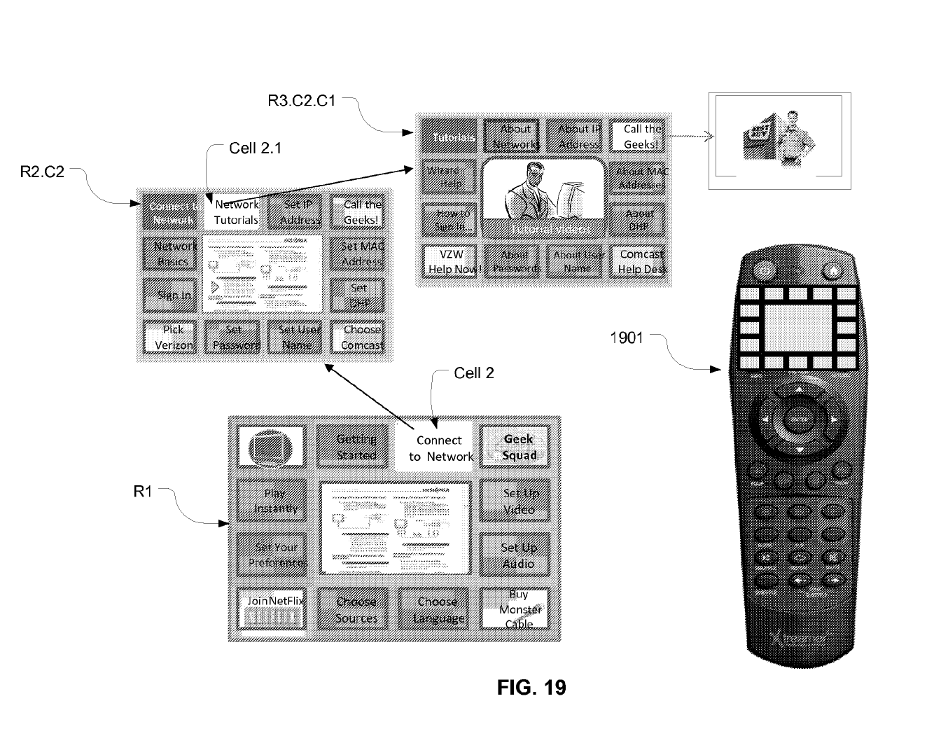

Another use case is to use a RingGuide-equipped remote control, such as a smartphone, a tablet device like the Apple iPad, a display-equipped remote control or personal media player, to directly interface with and control the RingGuide on a television or other screen, either in the same room device or at a distance. In one such embodiment, RingGuide is installed on a display-equipped remote control such as the remote control 1901 illustrated in FIG. 19 and is touched by the user to initiate the same functions as those on the onscreen RingGuide. This direct mapping of identical controls is an efficient and intuitive way to remotely control devices.

Another use case is for a RingGuide-equipped remote control 1901 for the control of multiple devices. For a television, a RingGuide would include Cells linking to control of the picture quality, programming guide, volume, etc. For a DVD player, the RingGuide would provide play, pause, skip forward, skip backward, ability to navigate a DVD's menus, etc.

Another use case is to use RingGuide the default user interface for many devices. To provide a consistent user experience for their buyers, the device manufacturer builds the Ring interface into the firmware of their machines, loading device-specific instructional videos into flash memory. When the device buyer turns on their new product, they see the video set-up instructions playing within the content window, surrounded by related subjects. The buyer can navigate through the Ring interface to watch other videos, which can include ads for installation services and support. Once the device connection is opened to the network, the device connects to the RingGuide application and ad servers, which load updated instructional videos, promotions for speaker cable, content downloads or rentals, etc. In this way, the consumer uses one interface to configure, connect, discover, collect and share media on their new device. The Ring's extensible, modular structure enables an integrated vertical customer experience that increases revenue and customer satisfaction.

As shown in FIG. 19, RingGuide is built in to a new Internet TV. The TV is plugged in and turned on, and the Ring interface is then used set up the cabling, network connections, etc. If desired, the remote control 1901 can be used to interact with the Ring interface during the process. The initial Ring R1 includes Link Cells that take the user to the various aspects of setting up the device such as “Set Up Video,” “Set Up Audio,” “Choose Language,” etc. Cell 2 is a Link Cell to Ring R2.C2 for connecting to the network. Cell 2.1 is a Link Cell connecting to Ring R3.C2.C1 which contains tutorials. One of the Link Cells goes to a sub-Ring to set up the device's network connectivity which in turn includes Link Cells to various tutorials. Each Ring contains advertising of interest to the user at that moment, such as cables, installation contractors, and content sources.

RingPIN

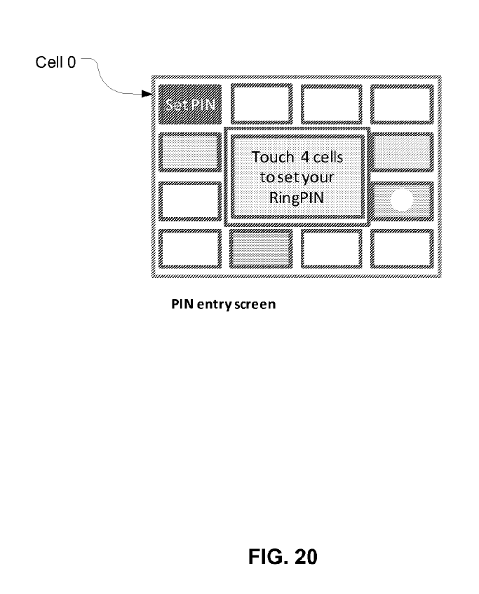

The Ring interface can be used to create shorthand or macro-like codes that trigger actions such as registering to a device or service, accessing parentally controlled content, confirming identity, opening a message to a pre-determined recipient, sending a whole pre-determined message or entering a credit card number. A RingPIN comprises a sequence of Cells within a Ring. An example RingPIN can be the sequence {C5, C1, C7, C10}. A user can choose different lengths of RingPINs for different functions. The RingPINs do not need to all be the same length. In the interface, the Cells can be numbers, colors, letters, glyphs, graphics, photos or any combination thereof. The user can choose whatever dressing for the Cells that makes it easiest for the user to remember the sequence that is the RingPIN. Referring to FIG. 20, the Cells of Ring R1 are colors. Thus the user can choose to remember the RingPIN as a sequence of colors rather than a sequence of numbered Cells. After setting the RingPINs, the user selects Cell 0 to set the Ring Pin. RingPINs can be set up to create shortcuts to any function of a user's RingGuide. When the user selects the Cells for the Ring Pin, the associated functionality is executed. RingPINs can be assigned to any function (or set of functions, e.g., a macro) that are supported by a device (or system) controlled by a RingGuide.

RingGuide Shopping Comparison Engine

RingGuide's SMSS can be combined with a device capable of receiving inputs of bar codes or RFID to provide a powerful tool for users who need to access and flexibly organize information available from the internet while mobile. In one example, a user is at a store to purchase a stand mixer. The user would be interested in price comparisons but also product reviews. After inputting the bar code or other product identifier for a stand mixer, RingGuide runs searches on shopping sites as well as product review sites and arranges all of those results in a single Ring displayed to the user on their mobile device. “Filter Cells’ that define specific websites to be searched can be customized by the user. For example, the user can ensure one of the simultaneous searches is on a recall website to ensure the mixer is not subject to a recall.

Creating Media Clips

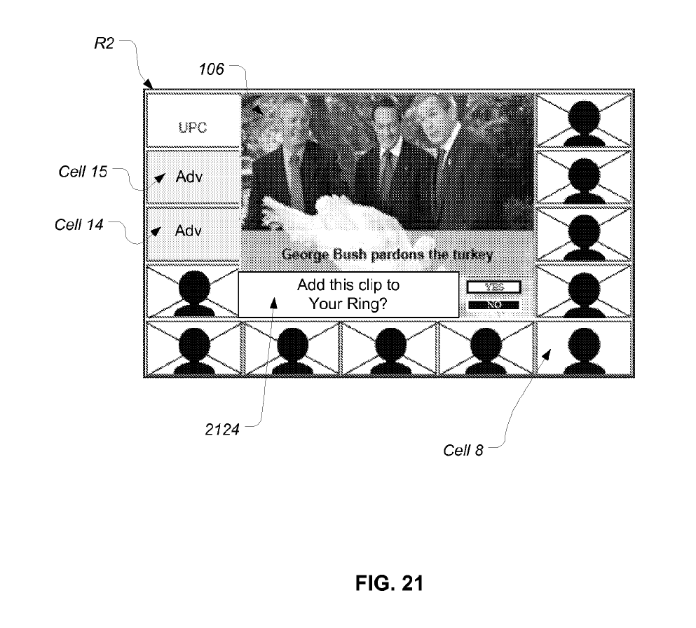

Referring to FIG. 21, a user is watching a video. The user may choose to save the currently playing video (or “clip”) to a personal sub-Ring (a user may have multiple sub-Rings). Here, the user has selected the currently playing video using a key on the input device. The user's personal sub-Ring R2 is displayed. The selected video continues to play in the center window 106. A prompt 2124 is shown asking the user to confirm whether to add the video clip to the user's personal sub-Ring R2. Cell 8 is available for the video clip and is identified to the user as where the video will be placed. Cells 4-7 and 9-13 are already occupied as illustrated with silhouettes of persons with an “X” there through. In addition, cells 14 and 15 are reserved by the RingGuide hosting service 200 to insert advertisements. These advertisements will appear when the user accesses R2, as well as when the user shares this sub-Ring with others. The session server 202 updates the user's profile in the user database with the necessary data to maintain the user's sub-Ring information.

In addition to adding the entire video, the user has the option of saving just a short piece of the currently playing video to the personal sub-Ring. The duration and content of the clip can be algorithmically determined or set through business rules defined by the content owner.

RingClock

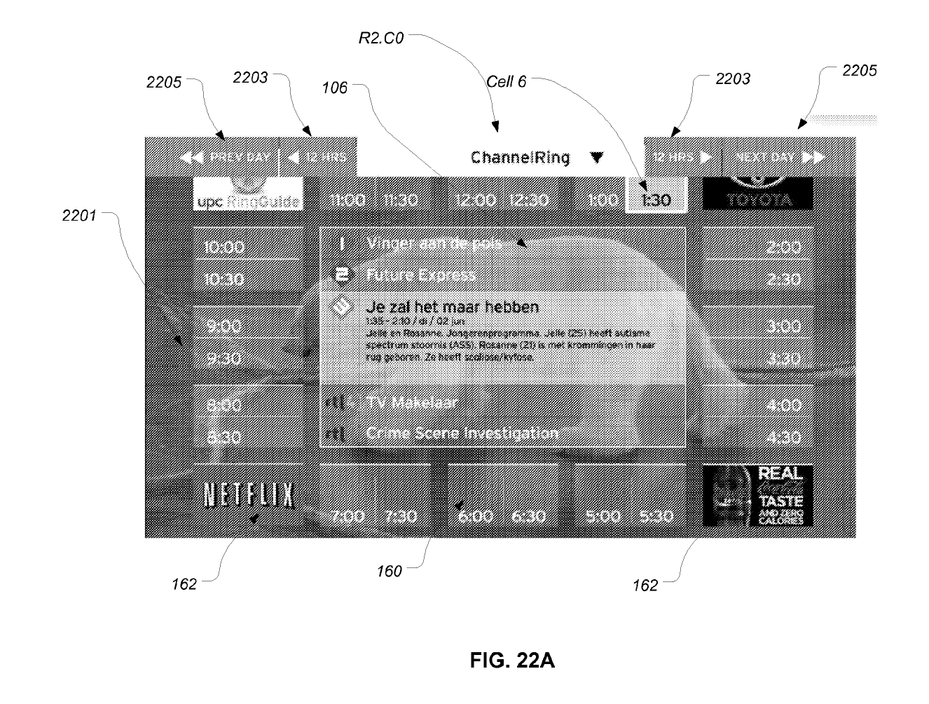

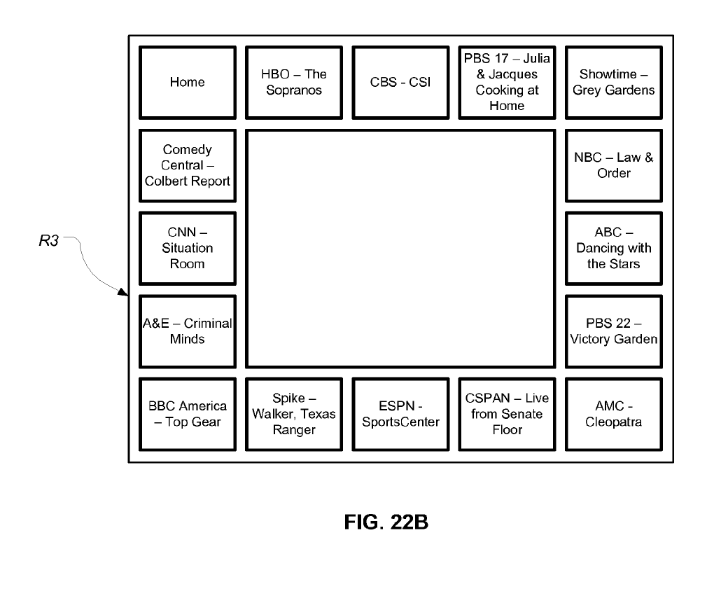

FIG. 22 shows a RingGuide electronic program schedule guide, RingClock. In one embodiment, the RingClock R2.C0, which shows channel and time information, is invoked by selecting “RingClock” from the Home Ring's menu picklist in Cell 0. The RingClock arranges 24 cells in a clockface of ½ hour time blocks, starting at either 12 am or 12 pm, depending on the current time (in this example, 1:30 pm, shown in Cell 6). The RingClock R2 can be overlaid in semi-transparent fashion over the current video program 2201. The user can navigate to the next or previous 12 hours via buttons 2203, and the next or previous day via buttons 2205. The time cells are arranged clockwise around the periphery of the user interface. Corner Cells 7, 14 and 21 contain advertisements. As the user navigates (using left and right arrows, for example) around the time cells, the Content Window 106 shows a channel listing, which can be navigated using the up and down arrows (or equivalent keys). As the user navigates through the list of channels (each of which shows channel number, and program title), the currently focused channel expands to shown detailed information (time, date, program summary, etc.).

Each time block is a Link Cell which, when selected, invokes a ChannelsRing R3. Each ChannelsRing (and Overflow Rings if necessary) displays the channels available at the time represented by the previously selected time block. A Cell 0 picklist provides access to system commands.

When a ChannelsRing Cell is highlighted, a list of the programs available on that Channel is displayed in the Content Windows, with the program whose start time corresponds to the previously selected time block centered in the scrolling list and a synopsis of the program expanded beneath it in the Content Window. In another embodiment, a preview plays. A user selecting the Cell opens that channel in the full screen viewer. Alternatively, additional Channel or Time Cells can be accessed via the previously described spiral navigation method. The ability of the RingGuide system to “pivot” on orthogonal criteria is a fundamental attribute.

Optionally, RingClock is also a PVR Interface and users can use it to program the PVR to record programs. The Cell° picklist provides access to PVR commands. RingClock can be a standalone feature or part of the Global Media Guide. RingClock can also be included in other embodiments of RingGuide.

The figures depict various embodiments of the present invention for purposes of illustration only. One skilled in the art will readily recognize from the following discussion that alternative embodiments of the structures and methods illustrated herein may be employed without departing from the principles of the invention described herein.

As would be known to one of skill in the art, it is not necessary for the elements to be housed as shown; the elements can be hosted by other entities or in some cases may even stand-alone. In some implementations of the system, the various elements may also appear in different configurations. Furthermore, it is not necessary for every embodiment of the invention to include all of the elements depicted. Likewise, as other elements and subelements are described throughout the invention, it should be understood that various embodiments of the invention may exclude elements and sub-elements described, that theelements and sub-elements may be hosted in configurations other than those shown, and that elements and sub-elements, even within an element, may be hosted in different locations or by different entities than those shown, and that elements and sub-elements may be downloaded to RingGuide-equipped devices over one or more networks to extend, update, delete, or modify functionality.

As will be understood by those familiar with the art, the invention may be embodied in other specific forms without departing from the spirit or essential characteristics thereof. For example, the particular division of functionality between the various modules or components may differ from that described herein, given the variety of software development environments and hardware platforms that may be used to practice the invention. Thus, the particular functions of the transaction processing component, the model development component, and so forth may be provided in more or fewer modules. Also, the Statistical Model may be implemented in a variety of modes, including a neural network, a multivariate regression model, or any other model which classifies inputs based on statistical analysis of historical exemplars. Finally the particular capitalization or naming of the modules, protocols, features, attributes, data structures, or any other aspect is not mandatory or significant, and the mechanisms that implement the invention or its features may have different names or formats. Accordingly, the disclosure of the present invention is intended to be illustrative, but not limiting, of the scope of the invention, which is set forth in the following claims.

The present invention has been described in particular detail with respect to various embodiments, and those of skill in the art will appreciate that the invention may be practiced in other embodiments. In addition, those of skill in the art will appreciate the following aspects of the disclosure. First, the particular naming of the components, capitalization of terms, the attributes, data structures, or any other programming or structural aspect is not mandatory or significant, and the mechanisms that implement the invention or its features may have different names, formats, or protocols. Second, the system may be implemented via a combination of hardware and software, as described, or entirely in hardware elements. Third, the particular division of functionality between the various system components described herein is merely exemplary, and not mandatory; functions performed by a single system component may instead be performed by multiple components, and functions performed by multiple components may instead performed by a single component.

Some portions of above description describe the invention in terms of algorithms and symbolic representations of operations on information. These algorithmic descriptions and representations are the means used by those skilled in the data processing arts to most effectively convey the substance of their work to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware or hardware.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or the like, refer to the action and processes of a computer system, or similar electronic computing device, that manipulates and transforms data represented as physical (electronic) quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well-suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

1. A computer implemented method of enabling creation and sharing of a user defined collection of assets, the method comprising:
receiving a user selection, for inclusion in the user-defined collection, of at least one asset;
associating the user selected asset with a graphical arrangement of cells, each cell including a representation of an asset or a link that can be displayed (“Ring”); and
storing the user-defined Ring in a database.

2. The method of claim 1, further comprising: receiving a user selection, for inclusion in the user-defined collection of at least one link to another collection comprising at least one asset, wherein the another collection hierarchically depends from the user-defined collection of assets.

3. The method of claim 1, further comprising: reserving a cell within the user-defined Ring for inclusion of an asset of a third party within the user defined collection of assets and links.

4. The method of claim 1, where a plurality of Rings are linked together by a set of links, the method further comprising: organizing the links in a consistent extensible architecture in which the links are arranged in a collection of alphanumerical, graphical, audio, animations, video or other components representing the links.

5. The method of claim 1, further comprising: displaying the user-defined Ring in a consistent graphical representation on at least two different the display devices, independent of network conditions, software, or hardware technologies.

6. The method of claim 1, further comprising: distributing the user-defined Ring to at least one other user or to a certain location, either (i) in digital form upon physical media, (ii) in digital form within a network, or (iii) in digital form across two or more communication networks.

7. The method of claim 1, further comprising: receiving from a first user, a selection of a user-defined Ring of a second user; and receiving from the first user an input linking a cell of the user-defined Ring to a second Ring different than the user-defined Ring.

8. The method of claim 1, further comprising: including in the user defined Ring at least one of (i) an advertisement or (ii) a link to an advertisement, wherein the advertisement or the link to an advertisement is automatically placed within the Ring in response to at least one of (i) a user input, (ii) a third party input, (iii) an algorithmically driven automatic process.

9. The method of claim 8, wherein: the at least one of (i) an advertisement or (ii) a link to an advertisement is persistently maintained in the user-defined Ring whenever the Ring is distributed or modified.

10. The method of claim 1, further comprising: including in the user defined Ring at least one of (i) user-to-user message; (ii) computer executable code, or (iii) a widget, any of which is automatically placed within the Ring in response to at least one of (i) a user input, (ii) a third party input, or (iii) an algorithmically-driven automatic process.

11. The method of claim 1, further comprising: providing to the user at least one of (i) economic compensation, or (ii) social recognition for creation of the Ring.

12. The method of claim 11, wherein the economic compensation comprises at least one of (i) monetary payments, (ii) points, or (iii) credits.

13. The method of claim 12, further comprising: monitoring access to the cells in the user-defined Ring by other users; and providing the economic compensation to the user based on the monitored access.

14. The method of claim 13, further comprising: maintaining a bank of permissions from which a user can obtain a permission to allow access to the user defined Ring.

15. The method of claim 1, further comprising: triggering an action upon selection of a cell within a Ring, wherein the action which may be initiated by at least one of (i) user input, or (ii) an algorithmically-driven automatic process.

16. The method of claim 15, further comprising: responsive to the triggered action, determining whether a predefined condition for accessing the cell is satisfied prior to providing access to the cell.

17. The method of claim 1, further comprising: executing at least one algorithm to (i) determine an asset for including in a cell of a Ring; and (ii) then triggering one or more events.

18. The method of claim 1, wherein: the user defined Ring is created based upon the specific assets or links to a second Ring collection.

19. The method of claim 1, further comprising: responsive to the user-defined Ring being displayed, pre-identifying and preparing for display an audio-visual representation of a link to a second Ring hierarchically depending from the user-defined Ring.

20. The method of claim 1, wherein the another collection hierarchically depends from the user-defined collection of assets comprises a second Ring, further comprising: displaying the arrangement of cells of the user-defined Ring; displaying concurrently with the Ring a preview window; displaying within the preview window a preview of the assets associated with a second Ring.

21. The method of claim 20, further comprising: varying an order of display the preview of the asset based upon at least one of (i) user input or, (ii) an algorithmically-driven automatic process.

22. The method of claim 21, further comprising: pre-caching representations of assets of the second Ring for display, based upon at least one of (i) user input or, (ii) an algorithmically-driven automatic process, so as to increase systems responsiveness and minimize processor and network dependencies.

23.-49. (canceled)
